(19) United States
(12) Patent Application Publication
(10) Pub. No.: US 2013/0258901 A1
(43) Pub. Date: Oct. 3, 2013

(54) COMMUNICATION INTERFACE APPARATUS, COMPUTER-READABLE RECORDING MEDIUM FOR RECORDING COMMUNICATION INTERFACE PROGRAM, AND VIRTUAL NETWORK CONSTRUCTING METHOD

(71) Applicant: FUJITSU LIMITED, Kawasaki-shi (JP)

(72) Inventor: Tsutomu KAWAI, Kawasaki (JP)

(73) Assignee: FUJITSU LIMITED, Kawasaki-shi (JP)

(21) Appl. No.: 13/848,762

(22) Filed: Mar. 22, 2013

(30) Foreign Application Priority Data
Mar. 29, 2012 (JP) 2012-078323

(51) Int. Cl. H04L 12/24

(52) U.S. Cl. CPC H04L 41/0806
USPC 370/254

(57) ABSTRACT

A communication interface apparatus provided at a first information processing apparatus includes: a setting information obtaining unit that obtains setting information from a second information processing apparatus that is different from the first information processing apparatus, the setting information including a piece of virtual network identification information corresponding to a virtual network to which the first information processing apparatus belongs from among pieces of virtual network identification information for identifying virtual networks; a setup unit that sets up virtual network identification information according to the obtained setting information; a receiving unit that receives data from a communication network; a filtering unit that applies a filtering process to the received data according to the virtual network identification information that has been set up; and a transferring unit that transfers to the first information processing apparatus the data to which the filtering process has been applied.

### CROSS-REFERENCE TO RELATED APPLICATION

This application is based upon and claims the benefit of priority of the prior Japanese Patent Application No. 2012-078323, filed on Mar. 29, 2012, the entire contents of which are incorporated herein by reference.

### FIELD

The embodiments described herein are related to a communication interface apparatus.

### BACKGROUND

As a new form of utilization of ICT (Information and Communication Technology) system construction, cloud computing, which collectively manages hardware, software, data, and so on at, for example, a data center, has been attracting attention. Service arrangements of cloud computing include IaaS (Infrastructure as a Service). IaaS is a service for providing, for example, a network, hardware (CPUs, memories, hard disks), and an OS. In particular, a service for providing a user with physical resources such as a network and a server installed at a data center is called physical IaaS. A service for providing a user with a resource on a virtual environment constructed using a computing resource on a network is called virtual IaaS.

In IaaS, a VLAN (Virtual Local Area Network) is used as one technology for constructing a plurality of subnets on a physical network. The VLAN is a LAN (Local Area Network) achieved by virtually (logically) grouping terminals connected to a network independently from a physical LAN configuration, and one VLAN makes one broadcast domain. The VLAN is standardized by IEEE802.1Q (IEEE Standards for Local and Metropolitan Area Networks: Virtual Bridged Local Area Networks).

Technologies using such a VLAN include, for example, a technology for switching a VLAN communication method of a virtual network interface card (NIC) in accordance with whether or not a VLAN ID is set for the virtual NIC. In this technology, a control program for constructing a plurality of virtual machines that are capable of using the virtual NIC on hardware of a computer is operated in this computer. Configuration information of each virtual NIC is input by a console and is managed using a virtual-NIC-configuration management table on the control program.
Patent document 1: Japanese Laid-open Patent Publication No. 2007-158870

### SUMMARY

In one aspect of the present embodiment, a communication interface apparatus provided at a first information processing apparatus includes a setting information obtaining unit, a setup unit, a receiving unit, a filtering unit, and a transferring unit. From a second information processing apparatus that is different from the first information processing apparatus, the setting information obtaining unit obtains setting information that includes apiece of virtual network identification information corresponding to a virtual network to which the first information processing apparatus belongs from among pieces of virtual network identification information for identifying virtual networks. The setup unit sets up virtual network identification information according to the obtained setting information. The receiving unit receives data from a communication network. The filtering unit applies a filtering process to the received data according to the virtual network identification information that has been set up. The transferring unit transfers to the first information processing apparatus the data to which the filtering process has been applied.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a communication connection apparatus in accordance with the present embodiment.

FIG. 2 illustrates an example of a physical network configuration for physical IaaS and virtual IaaS in accordance with the present embodiment.

FIG. 3 illustrates an example of a physical server in accordance with the present embodiment (for physical IaaS).

FIG. 4 illustrates an example of a receiving process unit in accordance with the present embodiment.

FIG. 5 illustrates an example of a transmitting process unit in accordance with the present embodiment.

FIG. 6 illustrates an example of a management server in accordance with the present embodiment (for physical IaaS).

FIG. 7 illustrates exemplary configurations of frames before and after insertion of a VLAN tag.

FIG. 8 illustrates an example of a physical resource allocation table in accordance with the present embodiment (physical IaaS).

FIG. 9 illustrates an example of a network allocation table in accordance with the present embodiment (physical IaaS).

FIG. 10 illustrates an example of a management board information table in accordance with the present embodiment.

FIG. 11 illustrates an example of NIC setting information in accordance with the present embodiment.

FIG. 12 illustrates an example of an access control table which an NIC has in accordance with the present embodiment.

FIG. 13 illustrates an example of allocation of physical resources for each tenant in accordance with the present embodiment (for physical IaaS).

FIG. 14 illustrates an exemplary flow of an allocating process of allocating resources to a physical server performed by a management server in accordance with the present embodiment (for physical IaaS).

FIG. 15 illustrates an exemplary flow of a cancelling process of deallocation of resources of a physical server performed by the management server in accordance with the present embodiment (for physical IaaS).

FIG. 16 illustrates an example of an operation of a VLAN for each tenant in accordance with the present embodiment (for physical IaaS).

FIG. 17 illustrates an example of a command sequence between a host, a management board, and an NIC in accordance with the present embodiment (for physical IaaS).

FIG. 18 illustrates an example of a frame sequence between hosts in accordance with the present embodiment (for physical IaaS).

FIG. 19 illustrates an example of a physical server in accordance with the present embodiment (for virtual IaaS).

FIG. 20 illustrates an example of a management server in accordance with the present embodiment (for virtual IaaS).

FIG. 21 illustrates an example of a physical resource allocation table in accordance with the present embodiment (virtual IaaS).

FIG. 22 illustrates an example of a network allocation table in accordance with the present embodiment (for virtual IaaS).

FIG. 23 illustrates an example of a management board information table in accordance with the present embodiment (for virtual IaaS).

FIG. 24 illustrates an example of a virtual resource allocation table in accordance with the present embodiment (for virtual IaaS).

FIG. 25 illustrates an example of a VMM IP table in accordance with the present embodiment (for virtual IaaS).

FIG. 26 illustrates an example of a VM-VLAN-ID relationship table in accordance with the present embodiment (for virtual IaaS).

FIG. 27 illustrates an example of allocation of physical resources and virtual resources for each tenant in accordance with the present embodiment (for virtual IaaS).

FIG. 28 illustrates an exemplary flow of an allocating process of allocating resources to a physical server performed by a management server in accordance with the present embodiment (for virtual IaaS).

FIG. 29 illustrates an exemplary flow of a cancelling process of deallocation of resources of a physical server performed by the management server in accordance with the present embodiment (for virtual IaaS).

FIG. 30 illustrates an exemplary flow of an allocating process of allocating VMs to a physical server performed by a management server in accordance with the present embodiment (for virtual IaaS).

FIG. 31 illustrates an exemplary flow of a cancelling process of deallocation of VMs performed by the management server in accordance with the present embodiment (for virtual IaaS).

FIG. 32 illustrates an example of a command sequence between a host, a management board, and an NIC in accordance with the present embodiment (for virtual IaaS).

FIG. 33 illustrates an exemplary frame sequence between guest OSs and an exemplary frame sequence between a VMM and a management server in accordance with the present embodiment (for virtual IaaS).

FIG. 34 illustrates an exemplary process flow of an NIC with respect to access from a management board in accordance with the present embodiment (for physical IaaS and virtual IaaS).

FIG. 35 illustrates an exemplary process flow of an NIC with respect to access from a host in accordance with the present embodiment (for physical IaaS and virtual IaaS).

FIG. 36A, FIG. 36B, and FIG. 36C illustrate an exemplary flow of a receiving process of receiving a frame performed by an NIC in accordance with the present embodiment (for physical IaaS and virtual IaaS).

FIG. 37 illustrates an exemplary flow of a transmitting process of transmitting a frame performed by an NIC in accordance with the present embodiment (for physical IaaS and virtual IaaS).

FIG. 38 illustrates an example of a configuration block diagram of a hardware environment of a computer to which the present embodiment has been applied (pattern 1).

FIG. 39 illustrates an example of a configuration block diagram of a hardware environment of a computer to which the present embodiment has been applied (pattern 2).

### DESCRIPTION OF EMBODIMENTS

To provide physical IaaS, a separation of a network needs to be secured for each user. In the case of virtual IaaS, a tunnel function is implemented at a hypervisor layer that executes a plurality of virtual machines, so that the virtual machines can be connected to each other via a virtual network. Accordingly, the separation of the network is achievable without controlling the network.

In physical IaaS, however, an information processing apparatus (a host) provided with a network interface card (NIC) may operate the NIC. Thus, in order to secure the separation of a network for each user, control needs to be performed, e.g., a VLAN needs to be dynamically set up by a network apparatus such as an L2 switch apparatus or an L3 switch apparatus. As a result, when roles are divided in such a manner that a server manager sets up a server and a network manager sets up a network apparatus, the server manager is unable to set up the network apparatus. Accordingly, when different persons serve as the network manager and the server manager, there may possibly be a problem in an independence of the management system.

Therefore, in one aspect, the present invention provides a technology for securing a separation of a network for each user in a server management region.

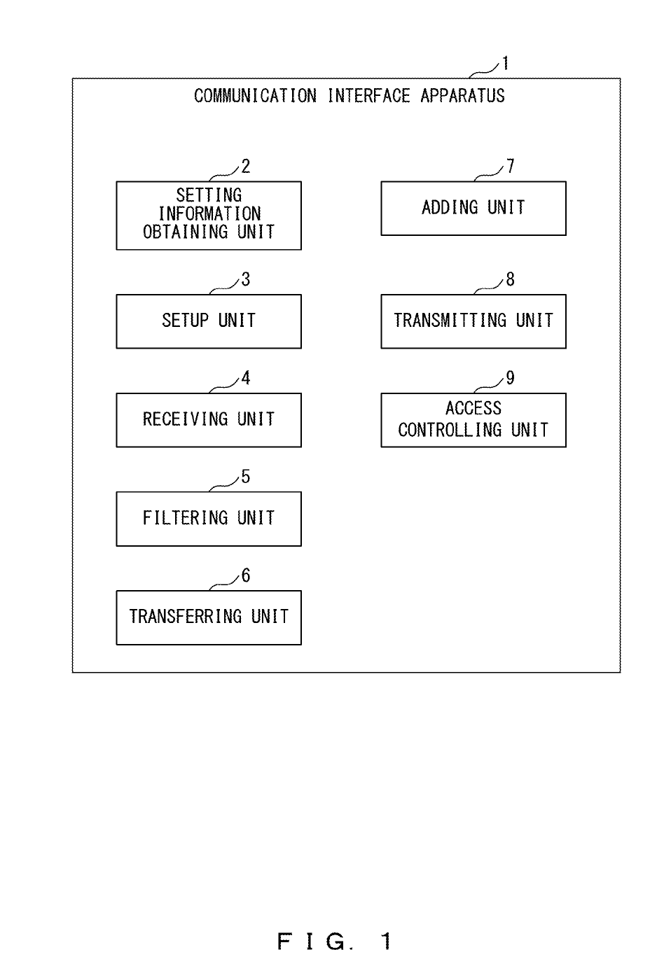

FIG. 1 illustrates an example of a communication interface apparatus in accordance with the present embodiment. A communication interface apparatus 1 is provided at a first information processing apparatus. A network interface card (NIC) 12 is an example of the communication interface apparatus 1. The communication interface apparatus 1 includes a setting information obtaining unit 2, a setup unit 3, a receiving unit 4, a filtering unit 5, and a transferring unit 6.

The setting information obtaining unit 2 obtains setting information from a second information processing apparatus (e.g., a management server 14) that is different from the first information processing apparatus (e.g., a physical server 11). From among pieces of virtual network identification information that identify virtual networks, the setting information includes a piece of virtual network identification information corresponding to a virtual network to which the first information processing unit belongs. A management-board-side management I/F 24 is an example of the setting information obtaining unit 2.

The setup unit 3 sets up virtual network identification information according to the obtained setting information. The management-board-side management I/F 24 is an example of the setup unit 3.

The receiving unit 4 receives data from a communication network. A signal receiving unit 31 is an example of the receiving unit 4.

The filtering unit 5 applies a filtering process to the received data according to the virtual network identification information that has been set up. A destination MAC confirming unit 33 and a VLAN ID confirming unit 34 are examples of the filtering unit 5.

The transferring unit 6 transfers the data to which the filtering process has been applied to the first information processing apparatus. A tag deleting unit 35 and a host-side reception I/F 36 are examples of the transferring unit 6.

Such a configuration allows a separation of a network for each user to be secured in a server management region without entering a network management region.

The filtering unit 5 determines whether virtual network identification is included in header information of the received data. When virtual network identification information is included in the header information, the filtering unit 5 determines whether the virtual network identification information of the header information is identical with the virtual network identification information that has been set up.

Such a configuration allows the presence/absence of a VLAN tag to be determined and the received data to be filtered in accordance with a VLAN tag value.

When it is determined that the virtual network identification information of the header is identical with the virtual network identification information that has been set up, the transferring unit 6 transfers, to the first information processing apparatus, data consisting of the header information with the virtual network identification information removed.

Such a configuration allows data consisting of header information with information that identifies a VLAN removed to be transferred to the host side after passing through the filtering unit 5.

The filtering unit further determines whether a destination address of the header of the received data is identical with an address set for a communication interface apparatus.

Such a configuration allows the received data to be filtered in accordance with the destination address of the received data.

The communication interface apparatus 1 further includes an adding unit 7 and a transmitting unit 8. The adding unit 7 adds, to the header information of the data received from the first information processing apparatus, the virtual network identification information that has been setup. A tag embedding unit 44 is an example of the adding unit 7.

The transmitting unit 8 transmits to the communication network the data to which the virtual network identification information has been added. A signal transmitting unit 41 is an example of the transmitting unit 8.

The communication interface apparatus further includes an access limiting unit 9. According to setting information, the access limiting unit 9 limits access from the first information processing apparatus to the setting information set for the communication interface apparatus. A host-side management I/F 23 is an example of the access limiting unit 9.

Such a configuration allows access from the first-information-processing-apparatus-side (the host side) to the setting information set for the communication interface apparatus to be limited so that an operation on the communication interface apparatus performed by the host can be limited. As a result, since the host is incapable of changing a setting of the VLAN, the host may be prevented from joining a VLAN that is different from the VLAN to which the host belongs. Accordingly, a separation of a network for each user may be secured.

The setting information obtaining unit 2 obtains the setting information from a communication apparatus (e.g., a management board 13) that is provided for the first information processing apparatus and is capable of communicating with the second information processing apparatus. Such a configuration allows the setting information obtaining unit 2 to obtain setting information from the second information processing apparatus.

In an example of the present embodiment, a function that will hereinafter be described is added to an NIC implemented in a physical server. The NIC in accordance with the present embodiment performs a filter process while exchanging packets with a network. For physical IaaS, the NIC performs a control such that a setting of the filter process is not made via access from inside the physical server.

A parameter may be set for the filter process using an apparatus that is not managed by a user, e.g., a port on the NIC exclusive to management or a server control board such as an IPMI (Intelligent Platform Management Interface).

When viewed from inside the server, the NIC in accordance with the present embodiment appears similar to an ordinary NIC. However, the NIC checks a VLAN tag when the server receives a frame, and the NIC discards the frame if it is unrelated. In the transferring of a frame to the host side, the NIC deletes a VLAN tag value and changes the frame back to an ordinary frame.

In the transmitting of a frame, the NIC transmits the frame as a frame of the VLAN of the user by adding a VLAN tag to the frame.

The following is another example of a method for using the NIC in accordance with the present embodiment. As an example, for frames transmitted and received in virtual IaaS, the NIC may select a VLAN used by a guest OS (Operating System) from among VLANs used by virtual IaaS and may receive a frame from this selected VLAN. As a result, loads on the host (a hypervisor or a VMM (Virtual Machine Monitor)) may be decreased. The guest OS indicates an OS set up at a VM operated on the host (VMM).

In addition to the VLAN tag, a protocol such as a GRE (Generic Routing Encapsulation) or an IPsec (Security Architecture for Internet Protocol) from header information may be used as a filter condition.

To provide an IaaS service using the NIC, a setting or a control system of the NIC is adjusted in accordance with whether the server is provided for a user as a physical server or whether the server deploys a client's VM under a condition in which the data center deploys a hypervisor as a virtual server.

For the use of the physical server, the NIC is made controllable from outside the host so as to isolate users. When the data center uses the physical server as a virtual host, control from the host side is permitted to enhance control flexibility.

In accordance with the present embodiment, an inter-user network may be separated only via server control without an operation on the network, so that requests of a function issued to the network side can be decreased and an operation during action can be avoided.

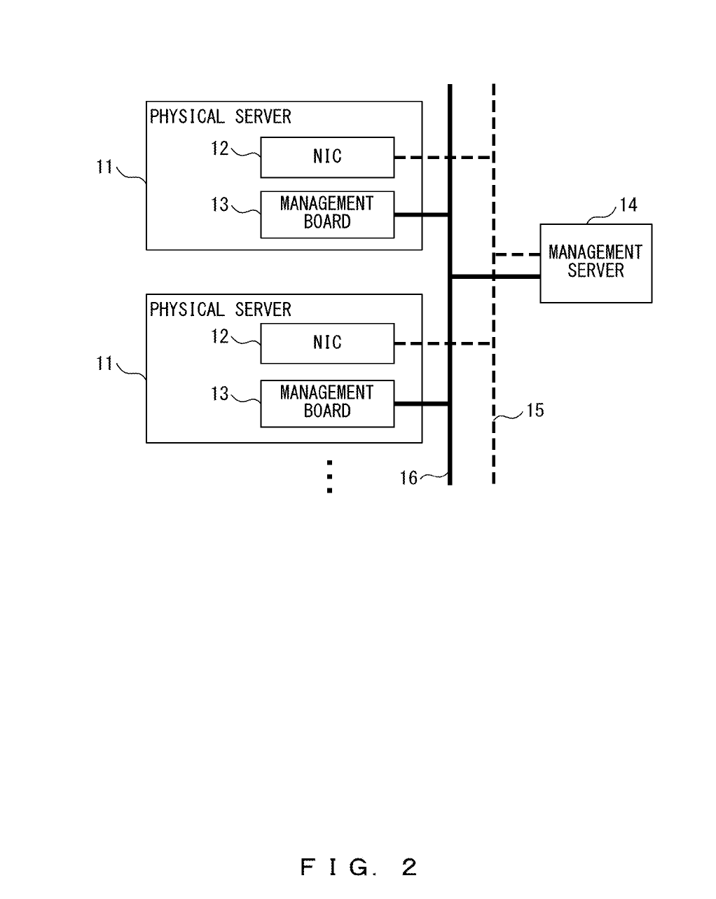

FIG. 2 illustrates an example of a physical network configuration for physical IaaS and virtual IaaS in accordance with the present embodiment. A plurality of physical servers 11 are connected via an operational network 16. The physical server 11 is connected to the operational network 16 via an NIC 12. The NIC 12 is a communication-network interface (I/F) that is connected to a communication network so that communication can be performed. The operational network 16 is a physical communication network used by a user for physical IaaS or virtual IaaS.

A management server 14 is connected to a management network 15 and the operational network 16. The management network 15 is a physical communication network to allow the management server 14 to manage and control an operation of the physical server 11. The physical server 11 is connected to the management network 15 via a management board 13. The management board 13 is a communication I/F that is used by the management server 14 in order to control and manage an operation of the physical server 11.

In the present embodiment, physical IaaS will be described first, then virtual IaaS will be described, and finally common points between physical IaaS and virtual IaaS will be described.

<Physical IaaS>

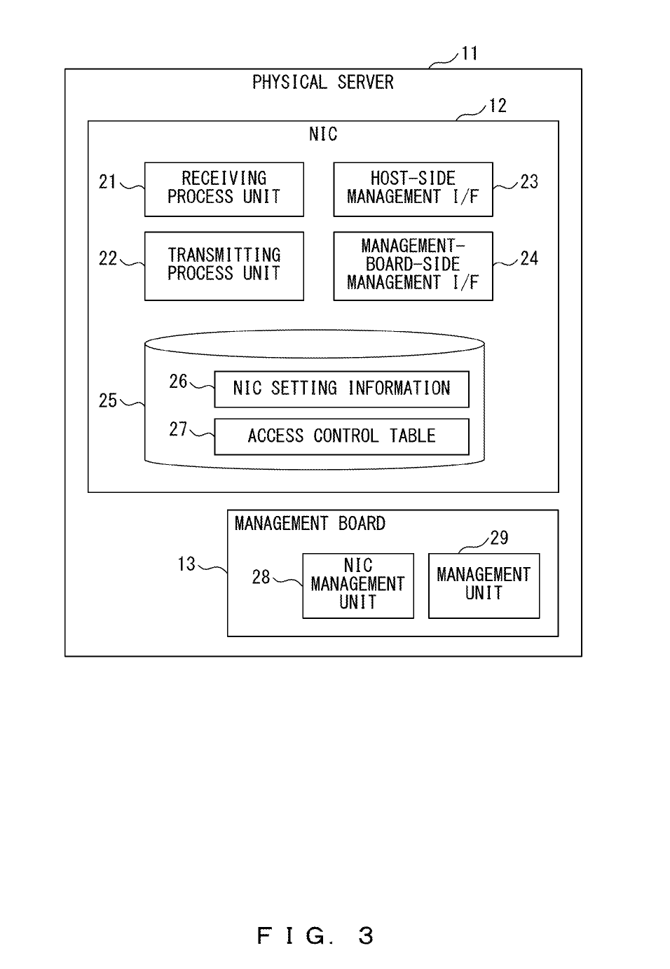

FIG. 3 illustrates an example of a physical server in accordance with the present embodiment (for physical Iaas). The physical server 11 includes the NIC 12 and the management board 13. The NIC 12 includes a receiving process unit 21, a transmitting process unit 22, a host-side management I/F 23, a management-board-side management I/F 24, and a storage unit 25.

The host-side management I/F 23 is a communication interface to communicate with a host with respect to a control related to the NIC 12. The host-side management I/F 23 controls access from the host according to an access control table 27.

The management-board-side management I/F 24 is a communication interface to communicate with an NIC management unit 28 of the management board 13. The management-board-side management I/F 24 controls access from the management board according to the access control table 27. The management-board-side management I/F 24 obtains, via the management board 13, setting information such as a tag value (a VLAN ID) of a VLAN tag transmitted from the management server 14. The management-board-side management I/F 24 sets the obtained setting information for the storage unit 25 as NIC setting information 26.

The receiving process unit 21 performs a process related to data reception. The transmitting process unit 22 performs a process related to data transmission. The storage unit 25 stores NIC setting information 26 and the access control table 27. The NIC setting information 26 relates to a setting of an operation of the NIC 12. The access control table 27 is used to control access to the NIC setting information 26.

The management board 13 includes an NIC management unit 28 and a management unit 29. The NIC management unit 28 manages and controls the NIC 12 via the management-board-side management I/F 24. According to an instruction from the management server 14, the management unit 29 controls a power supply of the physical server 11, monitors a temperature of the physical server 11, performs another process of controlling and monitoring the physical server 11, and reports a result of the monitoring to the management server 14.

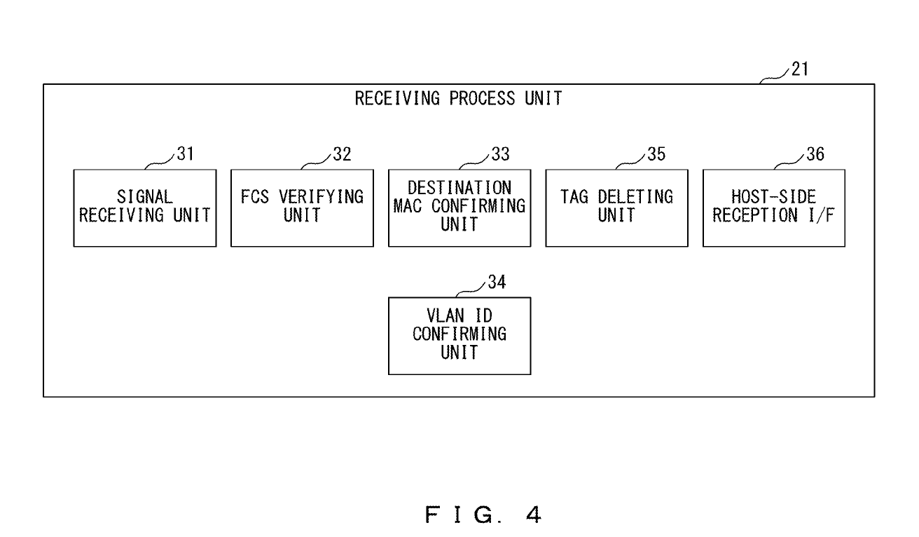

FIG. 4 illustrates an example of a receiving process unit in accordance with the present embodiment. A receiving process unit 21 includes a signal receiving unit 31, an FCS verifying unit 32, a destination MAC confirming unit 33, a VLAN ID confirming unit 34, a tag deleting unit 35, and a host-side reception I/F 36.

The signal receiving unit 31 receives a signal of data transmitted from a communication network connected to the NIC 12. Using frame check sequence (FCS) information included in a frame header of the received data, the FCS verifying unit 32 verifies whether there is an error in a header part or a data part of the received frame. The frame is a name of a protocol data unit (PDU) used in a communication of OSI (Open Systems Interconnection) layer 2. In the present embodiment, a MAC (Media Access Control) frame is used as an example of the frame.

According to a destination MAC address that is set by the header part of the received frame, the destination MAC confirming unit 33 passes through or discards the frame. According to a tag value (a VLAN ID) that identifies a VLAN that is set by the header part of the received frame, the VLAN ID confirming unit 34 passes through or discards the frame. The tag deleting unit 35 deletes the VLAN tag that is set by the frame. The host-side reception I/F 36 is an interface that transfers the frame received by the NIC 12 to the host side.

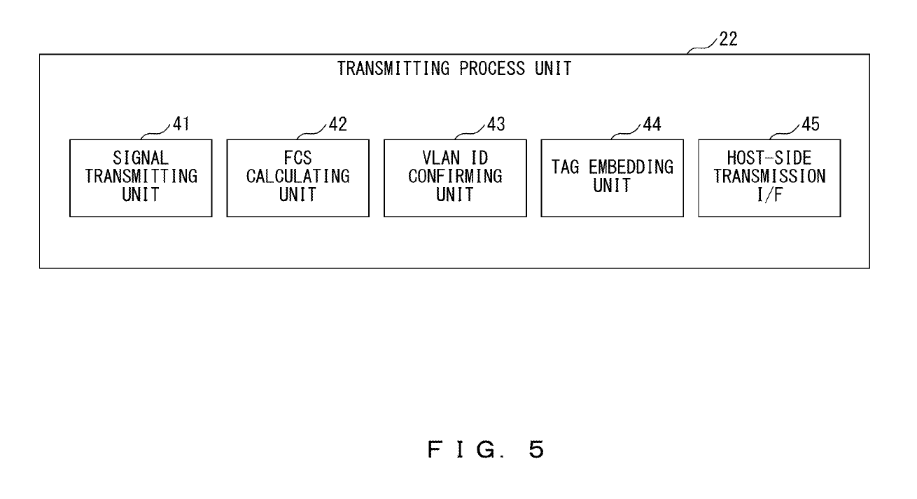

FIG. 5 illustrates an example of a transmitting process unit in accordance with the present embodiment. A transmitting process unit 22 includes a signal transmitting unit 41, an FCS calculating unit 42, a VLAN ID confirming unit 43, a tag embedding unit 44, and a host-side transmission I/F 45.

The host-side transmission I/F 45 receives frame data transferred from the host. The tag embedding unit 44 embeds a VLAN tag in a frame header. The VLAN ID confirming unit 43 determines whether there is a VLAN tag in a frame to be transmitted. The FCS calculating unit 42 calculates a frame check sequence for the frame to be transmitted and sets the calculated value in the frame header as FCS information. The signal transmitting unit 41 transmits a signal of the generated frame.

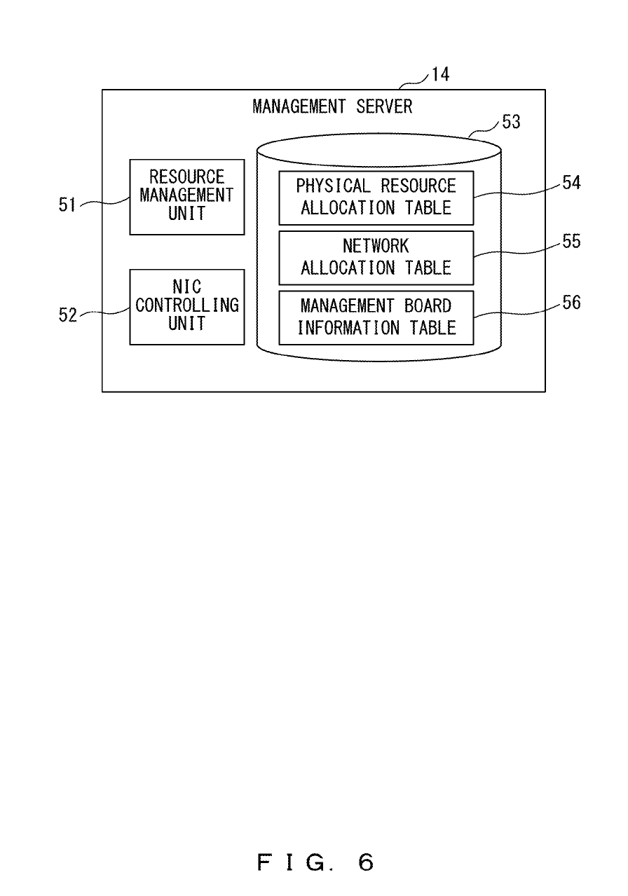

FIG. 6 illustrates an example of a management server in accordance with the present embodiment (for physical IaaS). A management server 14 includes a resource management unit 51, an NIC controlling unit 52, and a storage unit 53. The resource management unit 51 allocates, to each physical server 11, a physical resource (e.g., a server or a network) to be provided to a user. The NIC controlling unit 52 deletes the NIC setting information 26 of the NIC 12 of the physical server 11, writes VLAN information into the NIC setting information 26, and performs another process.

The storage unit 53 stores a physical resource allocation table 54, a network allocation table 55, and a management board information table 56. Information related to a resource allocated to the physical server 11 is stored in the physical resource allocation table 54. Information related to a VLAN present on an operational network 16 is stored in the network allocation table 55. Information related to a management board 13 provided for the physical server 11 is stored in the management board information table 56.

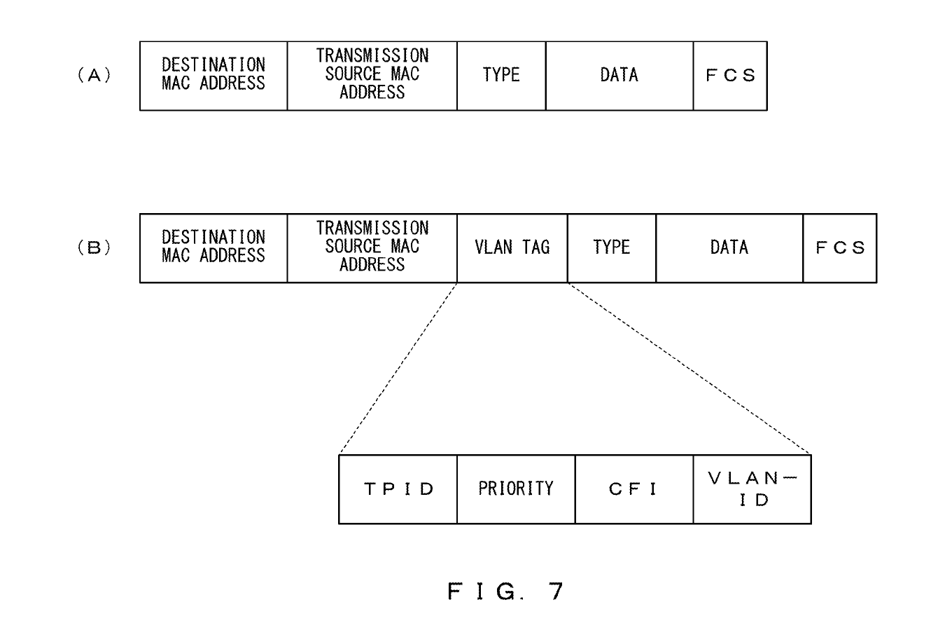

FIG. 7 illustrates exemplary configurations of frames before and after insertion of a VLAN tag. (A) in FIG. 7 illustrates a configuration of a frame in which a VLAN tag is not inserted. The frame includes fields of “destination MAC address”, “transmission destination MAC address”, “type”, “data”, and “FCS”. The MAC address of a destination is set in the “destination MAC address” field. The MAC address of a transmission source is set in the “transmission source MAC address” field. The type of a communication protocol is set in the “type” field. Data to be transmitted is set in the “data” field. Frame check sequence information is set in the “FCS” field.

(B) in FIG. 7 illustrates a configuration of a frame in which a VLAN tag has been inserted. The frame at (B) of FIG. 7 is the same as the frame at (A) in FIG. 7 to which “VLAN tag” field has been added. The “VLAN tag” field includes fields of “TPID (tag protocol identifier)”, “priority”, “CFI (Canonical Format Indicator)”, and “VLAN ID”. A value indicating that the frame is a tagged frame that conforms to the IEEE802.1Q standard is set in the “TPID” field. The priority of the frame is set in the “priority” field. Identification information for identifying a format is set in the “CFI” field. Identification information for identifying the VLAN (a tag value of the VLAN) is set in “VLAN ID”.

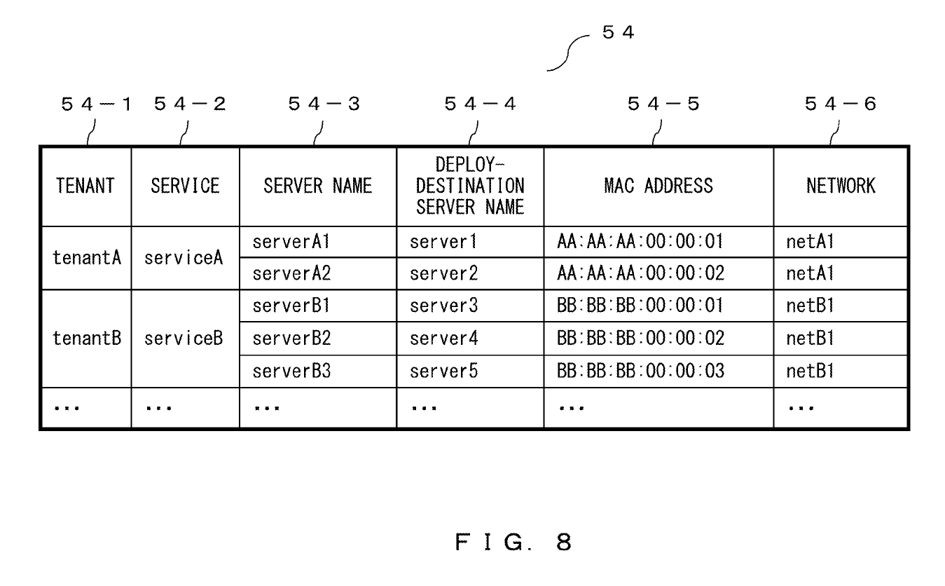

FIG. 8 illustrates an example of a physical resource allocation table in accordance with the present embodiment (physical IaaS). The physical resource allocation table 54 includes data headings of “tenant” 54-1, “service” 54-2, “server name” 54-3, “deploy-destination server name” 54-4, “MAC address” 54-5, and “network” 54-6.

Tenant names are stored in “tenant”. Tenant is a generic name for, for example, a company, a section, or a department that uses IaaS in a cloud computing infrastructure environment. The names of services used by the tenant are stored in “service” 54-2. The name of a server used by the tenant is stored in “server name” 54-3. Information for identifying the physical server 11 to which a resource is allocated (a deploy destination) is stored in “deploy-destination server name” 54-4. A MAC address allocated to the physical server 11 is stored in “MAC address” 54-5. The name of a network (a VLAN) that forms the tenant to which the physical server 11 belongs is stored in “network” 54-6.

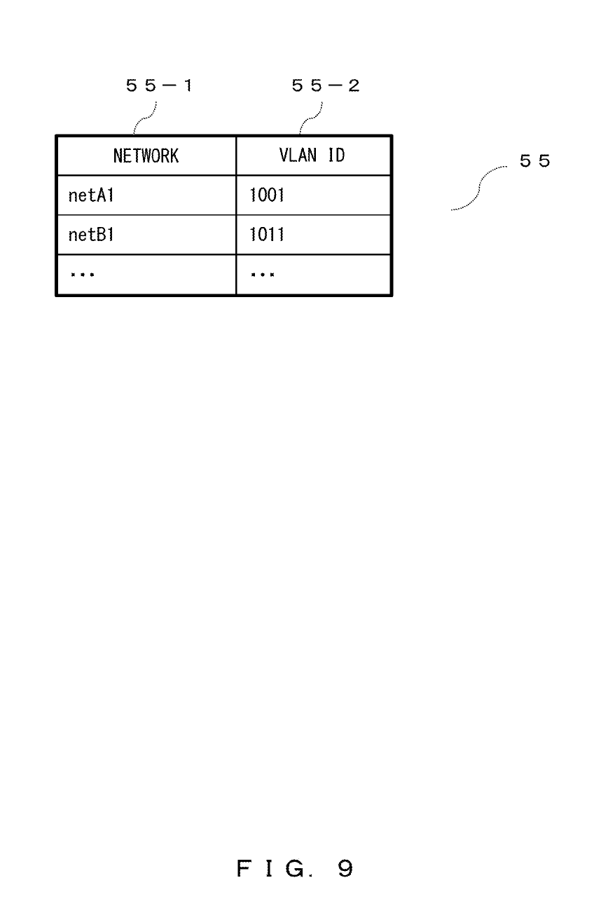

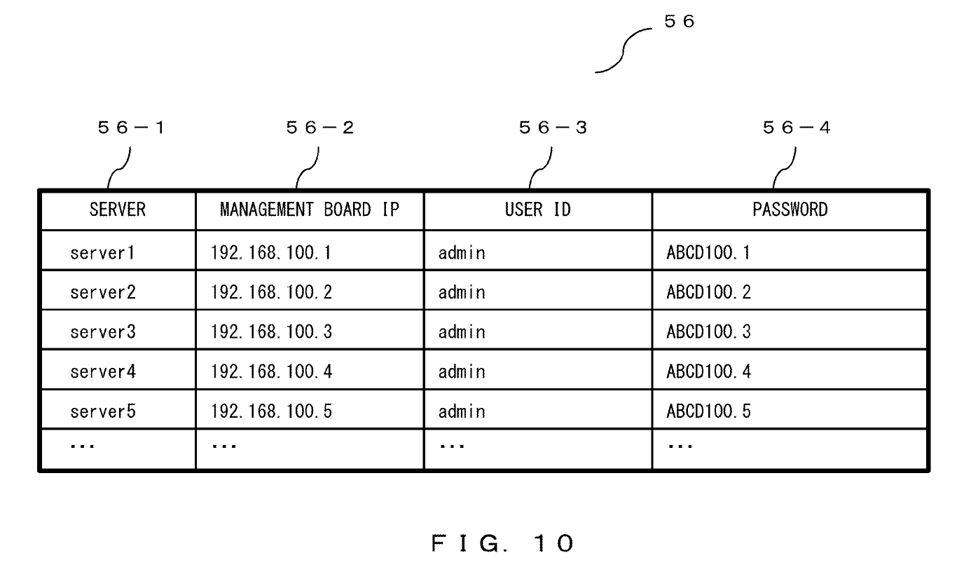

FIG. 9 illustrates an example of a network allocation table in accordance with the present embodiment (physical IaaS). The network allocation table 55 includes data headings of “network” 55-1 and “VLAN ID” 55-2. The names of VLANs are stored in “network” 55-1. The tag value (the VLAN ID) of the VLAN is stored in “VLAN ID” 55-2.

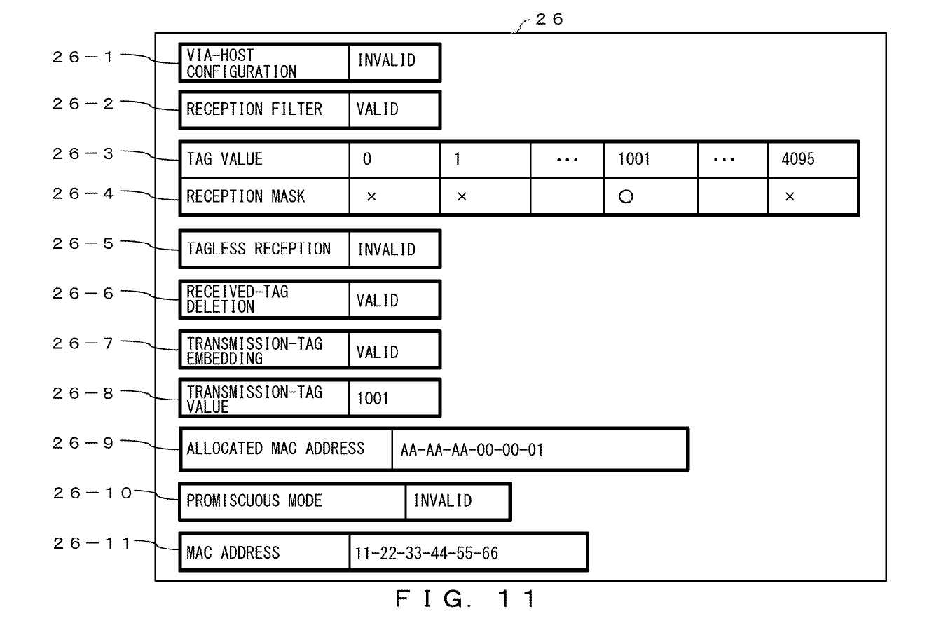

FIG. 10 illustrates an example of a management board information table in accordance with the present embodiment. The management board information table 56 includes data headings of “server” 56-1, “management board IP” 56-2, “user ID” 56-3, and “password” 56-4.

Information identifying the physical server 11 is stored in “server ID” 56-1. The IP (Internet Protocol) address of a management board is stored in “management board IP” 56-2. Information for identifying a user managing the management board (a user ID) is stored in “user ID” 56-3. A password that corresponds to the user ID is stored in “password” 56-4.

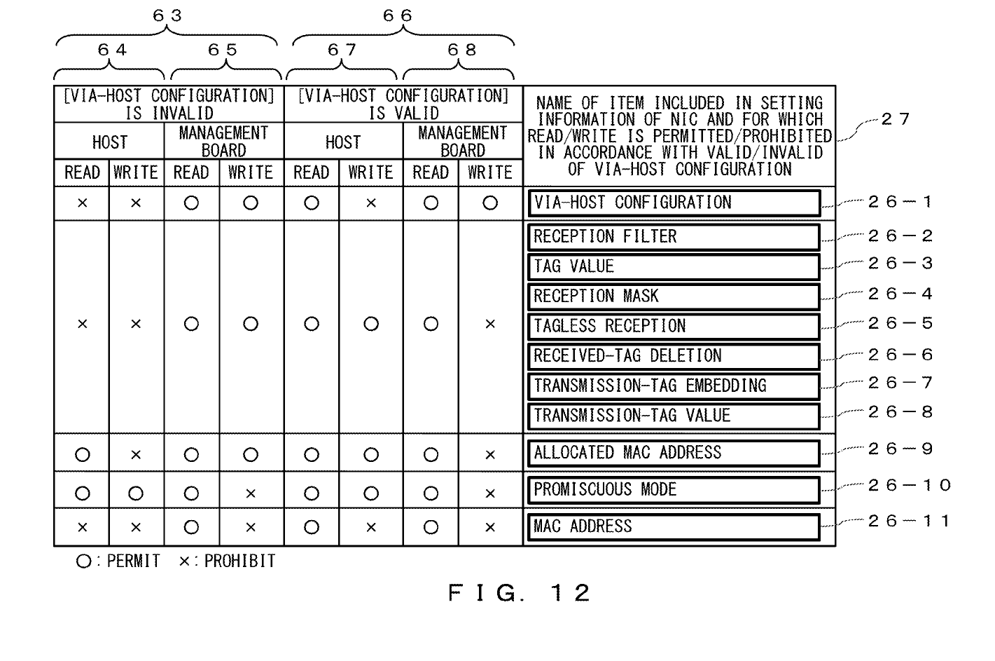

FIG. 11 illustrates an example of NIC setting information in accordance with the present embodiment. The NIC 12 includes NIC setting information 26. NIC setting information 26 includes setting items of “via-host configuration” 26-1, “reception filter” 26-2, “tag value” 26-3, “reception mask” 26-4, “tagless reception” 26-5, “received-tag deletion” 26-6, and “transmission-tag embedding” 26-7. In addition, NIC setting information 26 includes setting information of “transmission-tag value” 26-8, “allocated MAC address” 26-9, “promiscuous mode” 26-10, and “MAC address” 26-11.

Information indicating whether a VLAN is allowed to be or prohibited from being set up via a host (an OS of the physical server 11) is set in “via-host configuration” 26-1. Information indicating whether a reception filter function achieved by a filter process unit 33 is valid or invalid is set in “reception filter” 26-2.

A tag value (a VLAN ID) of the VLAN is set in “tag value” 26-3. According to the IEEE802.1Q standard, a VLAN tag ID is expressed by twelve bits, so values of, for example, 0 to 4095 are set. For the tag values set in “tag value” 26-3, information indicating whether a mask is valid (x) or invalid (o) is set in “reception mask” 26-4.

Information indicating whether a frame to which a VLAN tag is not given is allowed to be or prohibited from being received is set in “tagless reception” 26-5. Information indicating whether a VLAN tag given to a received frame is allowed to be or prohibited from being deleted is set in “received-tag deletion” 26-6.

Information indicating whether a VLAN tag is allowed to be or prohibited from being given to a frame in the transmitting of this frame is set in “transmission-tag embedding” 26-7. A tag value (a VLAN ID) of a VLAN tag of a transmission source is set in “transmission-tag value” 26-8 when transmission is performed.

A MAC address allocated to an OS is set in “allocated MAC address” 26-9. Information indicating whether a promiscuous mode is valid or invalid is set in “promiscuous mode” 26-10. Note that, in the promiscuous mode, packets addressed to any destination are received indiscriminately.

A MAC address specific to the NIC 12 is set in “MAC address” 26-11.

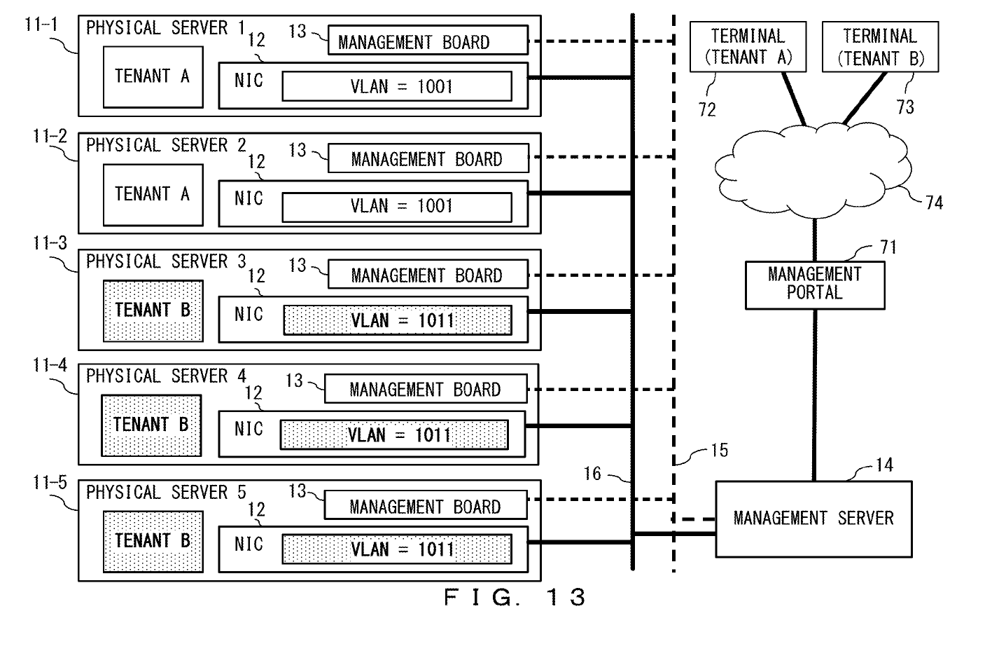

FIG. 12 illustrates an example of an access control table which an NIC has in accordance with the present embodiment. In accordance with “valid/invalid” of “via-host configuration” 26-1, the access control table 27 performs a control to permit or prohibit the host's reading from/writing to each setting item of NIC setting information 26. In the access control table 27, a setting item allowed to be accessed (written or read) is indicated by “o”. A setting item prohibited from being accessed (written or read) is indicated by “x”.

When “invalid” is set in “via-host configuration” 26-1, an access control is performed on the setting items of “reception filter” 26-2 to “MAC address” 26-11 as indicated by reference code 63. In this case, a control performed on access (reading or writing) by the host (an OS of the physical server 11) is indicated by reference code 64. A control performed on access (reading or writing) by the management server 14 via the management board 13 is indicated by reference code 65.

When “valid” is set in “via-host configuration” 26-1, an access control is performed on “reception filter” 26-2 to “MAC address” 26-11 as indicated by reference code 66. In this case, a control performed on access (reading or writing) by the host (an OS of the physical server 11) is indicated by reference code 67. A control performed on access (reading or writing) by the management server 14 via the management board 13 is indicated by reference code 68.

Next, physical IaaS will be described using further detailed examples.

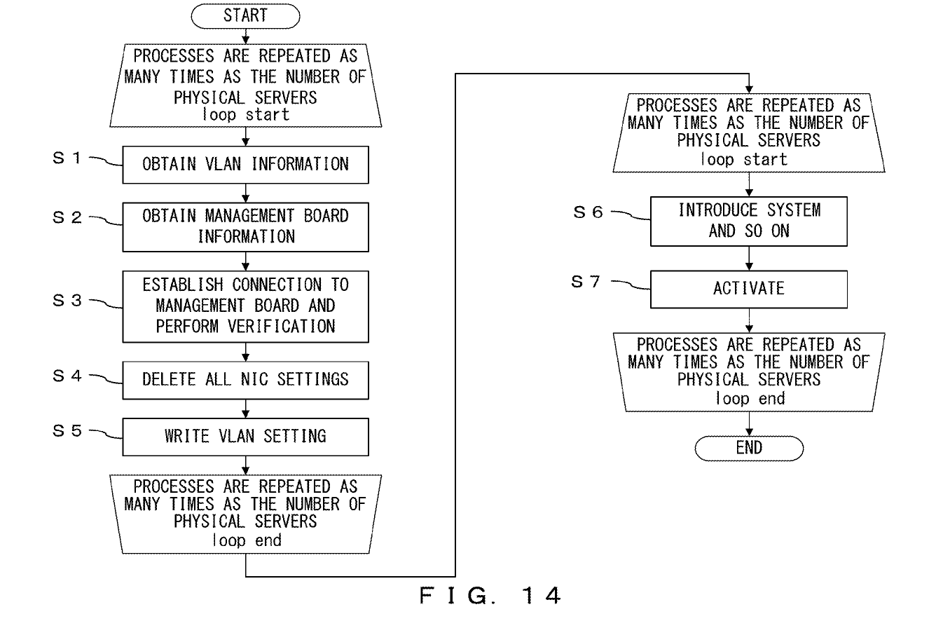

FIG. 13 illustrates an example of allocation of physical resources for each tenant in accordance with the present embodiment (for physical IaaS). The physical IaaS in FIG. 13 includes physical servers 1 to 5 (11-1 to 11-5), a management server 14, a portal server 71, a terminal A (72), and a terminal B (73). The physical servers 1 to 5 (11-1 to 11-5) are connected to the operational network 16 via the NICs 12. The physical servers 1 to 5 (11-1 to 11-5) are connected to the management network 15 via the management boards 13. The management server 14 is connected to the management network 15 and the operational network 16. The management server 14 is connected to the portal server 71.

The portal server 71 is connected to the terminal A (72) and the terminal B (73) via a network 74 for a tenant manager. The terminal A (72) is an information processing terminal used by a manager of a tenant A. The terminal B (73) is an information processing terminal used by a manager of a tenant B. The portal server 71 is a portal server of the physical IaaS. Using the terminal 72 or 73, the tenant manager allocates a resource to a target physical server 11 via the portal server 71.

As an example, using the terminal A (72), the manager of the tenant A gives an instruction to allocate the physical server 1 (11-1) and the physical server 2 (11-2) on behalf of the tenant A. Accordingly, the NIC controlling unit 52 of the management server 14 sets the tag value “1001” of a VLAN tag in the NIC setting information 26 of the physical server 1 (11-1) and the physical server 2 (11-2) via the management network and the management board 13. Moreover, the resource management unit 51 of the management server 14 allocates systems such as an OS and middleware to the physical server (11-1) and the physical server 2 (11-2).

Meanwhile, as an example, using the terminal B (73), the manager of the tenant B gives an instruction to allocate the server 3 (11-3), the server 4 (11-4), and the server 5 (11-5) on behalf of the tenant B. Accordingly, the NIC controlling unit 52 of the management server 14 sets the tag value “1011” of a VLAN tag in the NIC setting information 26 of the server 3 (11-3), the server 4 (11-4), and the server 5 (11-5) via the management network 16 and the management board 13. Moreover, the resource management unit 51 of the management server 14 allocates systems such as an OS and middleware to the server 3 (11-3), the server 4 (11-4), and the server 5 (11-5).

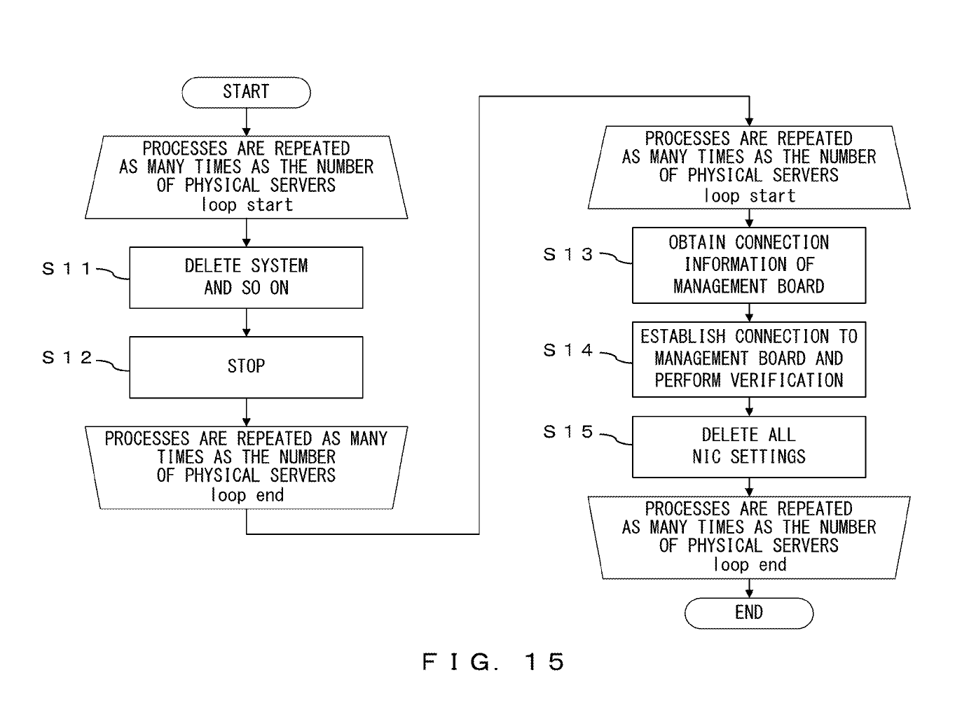

FIG. 14 illustrates an exemplary flow of an allocating process of allocating resources to a physical server performed by a management server in accordance with the present embodiment (for physical IaaS). In the present embodiment, physical resources provided to users (e.g., a server and a network) are decided on in advance.

The management server 14 reads one record from the physical resource allocation table 54. Using “network” 54-6 of the read record as a key, the management server 14 obtains from the network allocation table 55 a tag value (a VLAN ID) stored in “VLAN ID” 55-2 (S1).

Next, using the “deploy-destination server name” 54-4 of the read record as a key, the management server 14 obtains from the management board information table 56 management board information (a management board IP, a user ID, and a password) corresponding to the deploy-destination server name (S2).

The management server 14 establishes a connection to the management board 13 and transmits the user ID and the password to the management board 13 that corresponds to the management board IP of the obtained management board information. Using a user ID and a password registered in the management board 13 in advance, the management board 13 performs verification against the user ID and the password that have been transmitted (S3).

After the verification is performed by the management board 13, the management server 14 gives, via the management board 13, an instruction to delete the NIC setting information 26 of the NIC 12 provided at the physical server 11 (S4). In the NIC 12, according to the instruction information, the management-board-side management I/F 24 deletes (initializes) the NIC setting information 26 from the storage unit 25.

Via the management board 13, the management server 14 transmits, to the NIC 12 of the physical server 11 that includes this management board 13, setting information including setting items of NIC setting information 26 that will be described hereinafter, such as the tag value obtained in S1 and the MAC address obtained from the physical resource allocation table 54 (S5). In the NIC 12, upon receipt of the setting information, the management-board-side management I/F 24 sets up NIC setting information 26 according to the setting information. In particular, in relation to “tag value” 26-3 and “reception mask” 26-4 of the NIC setting information 26, the management-board-side management I/F 24 invalidates the mask of “reception mask” 26-4 that corresponds to the obtained tag value (o), and the management-board-side management I/F 24 validates the mask for the other tag values (x). Moreover, the management-board-side management I/F 24 sets “invalid” in “via-host configuration” 26-1. The management-board-side management I/F 24 sets “valid” in “reception filter” 26-2. The management-board-side management I/F 24 sets “invalid” in “tagless reception” 26-5. The management-board-side management I/F 24 sets “valid” in “received-tag deletion” 26-6. The management-board-side management I/F 24 sets “valid” in “transmission-tag embedding” 26-7. The management-board-side management I/F 24 sets the obtained tag value (a VLAN ID) in “transmission-tag value” 26-8. The management-board-side management I/F 24 sets “MAC address” 54-5 obtained from the physical resource allocation table 54 in “allocated MAC address” 26-9. The management-board-side management I/F 24 sets “invalid” in “promiscuous mode” 26-10.

The management server 14 repeats the processes of S1 to S5 as many times as the number of the physical servers 11 to which resources are allocated. When the processes of S1 to S5 are finished for all of the physical servers 11 to which resources are allocated, the management server 14 will perform the following processes. That is, for each physical server 11, the management server 14 performs, via the management board 13, a control on, for example, introduction of user systems such as an OS and middleware (S6), and activates the physical server 11 (S7).

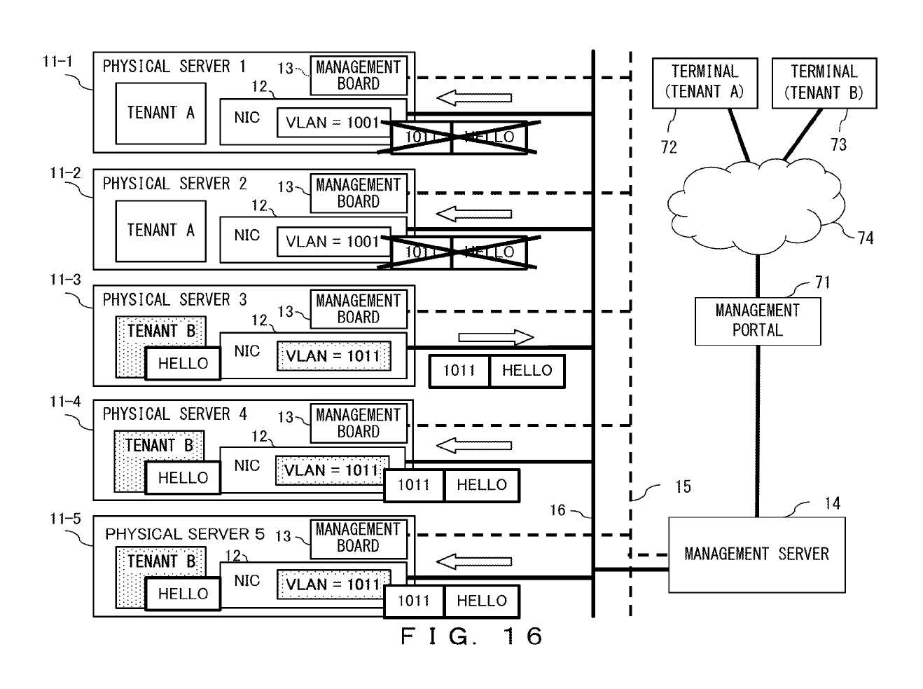

FIG. 15 illustrates an exemplary flow of a cancelling process of deallocation of resources of a physical server performed by the management server in accordance with the present embodiment (for physical IaaS). Via the management board 13, the management server 14 performs a control on, for example, deletion of user systems such as an OS and middleware of each physical server 11 (S11), and stops the physical server 11 (S12).

The management server 14 reads one record from the physical resource allocation table 54. Using “deploy-destination server name” 54-4 of the read record as a key, the management server 14 obtains from the management board information table 56 management board information (a management board IP, a user name, and a password) corresponding to the deploy-destination server name (S13).

The management server 14 establishes, via the management network 15, a connection to and transmits the user name and the password to the management board 13 that corresponds to the management board IP of the obtained management board information. Using a user name and a password registered in the management board 13 in advance, the management board 13 performs verification against the user name and the password that have been transmitted (S14).

After the verification is performed by the management board 13, the management server 14 gives, via the management board 13, an instruction to delete the NIC setting information 26 of the NIC 12 provided at the physical server 11 (S15). In the NIC 12, according to the instruction information, the management-board-side management I/F 24 deletes (initializes) the NIC setting information 26 from the storage unit 25.

The management server 14 repeats the processes of S13 to S15 as many times as the number of physical servers 11 for which allocation of resources is cancelled.

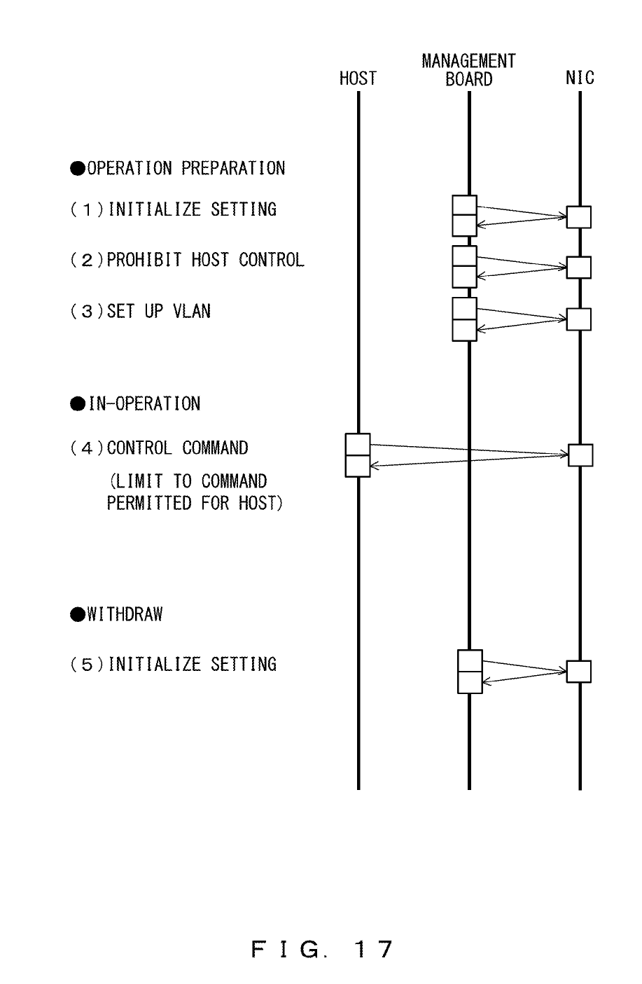

FIG. 16 illustrates an example of an operation of a VLAN for each tenant in accordance with the present embodiment (for physical IaaS). As described above with reference to FIG. 13, the tenant A is allocated to the physical server 1 (11-1) and the physical server 2 (11-2). A VLAN tag value=“1001” is set in the NIC setting information 26 of the physical server 1 (11-1) and the physical server 2 (11-2).

The tenant B is allocated to the physical server 3 (11-3), the physical server 4 (11-4), and the physical server 5 (11-2). A VLAN tag value=“1011” is set in the NIC setting information 26 of the physical server 3 (11-3), the physical server 4 (11-4), and the physical server 5 (11-2).

As an example, assume that the physical server 3 (11-3) transmits data to the other physical servers within the tenant B. In this case, the NIC 12 of the physical server 3 (11-3) embeds a VLAN tag in a frame to be transmitted and transmits this frame to the operational network 16. The frame in which the VLAN tag has been embedded is transmitted via the operational network 16 and reaches the respective NICs 12 of the physical server 1 (11-1), the physical server 2 (11-2), the physical server 4 (11-4), and the physical server 5 (11-5).

In this case, the NICs 12 of the physical server 4 (11-4) and the physical server 5 (11-5) determine that the tag value of the VLAN tag of the received frame is identical with the tag value that is set in the NIC setting information 26 of these NICs 12. The NICs 12 of the physical server 4 (11-4) and the physical server 5 (11-5) then remove the VLAN tag from the received frame and transfer the frame from which the VLAN tag has been removed to the host side.

Meanwhile, since the tag value of the VLAN tag of the received VLAN tag frame is not identical with the tag value that is set for the NICs 12 of the physical server 1 (11-1) and the physical server 2 (11-2), these NICs 12 discard the frame.

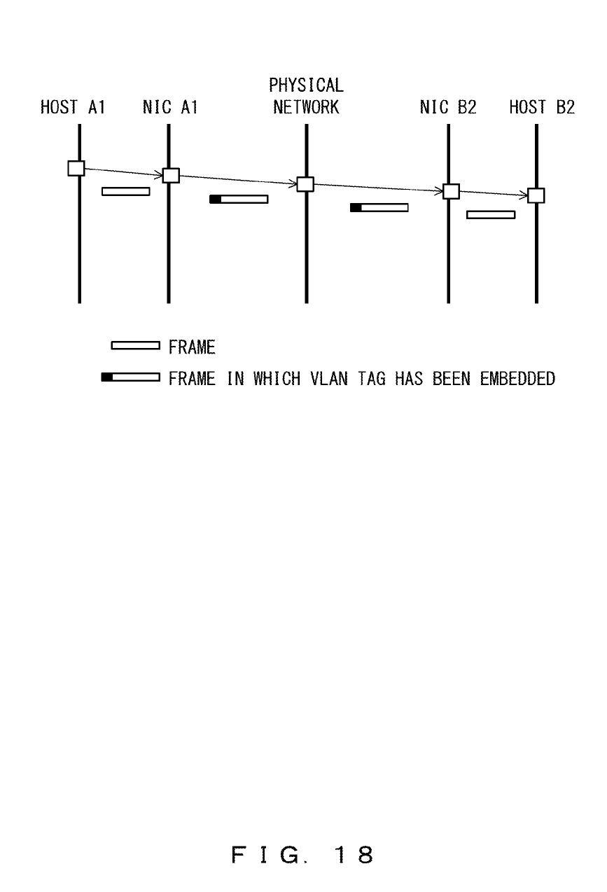

FIG. 17 illustrates an example of a command sequence between a host, a management board, and an NIC in accordance with the present embodiment (for physical IaaS). In an operation preparation stage of physical IaaS, (1) to initialize a setting of the NIC 12, the management board 13 gives the NIC 12 an instruction to initialize NIC setting information 26 according to an instruction from the management server 14. According to the instruction, the NIC 12 initializes the NIC setting information 26. Upon completion of the initialization, the NIC 12 reports to the management board 13 that the initialization has been completed.

In the operation preparation stage of physical IaaS, (2) to prohibit access from the host to the NIC 12, the management board 13 gives the NIC 12 an instruction to “invalidate” “via-host configuration” 26-1 of NIC setting information 26 according to an instruction from the management server 14. According to the instruction, the NIC 12 sets “invalid” in “via-host configuration” 26-1 of the NIC setting information 26. Upon completion of updating of NIC setting information 26, the NIC 12 reports to the management board 13 that the updating of NIC setting information 26 has been completed.

In the operation preparation stage of physical IaaS, (3) to set up a VLAN, the management board 13 gives the NIC 12 an instruction to set a tag value designated by the management server 14 in NIC setting information 26 according to an instruction from the management server 14. According to the instruction, the NIC 12 puts into an invalid state (o) “reception mask” 26-4 of “tag value” 26-3 that corresponds to the tag value designated by the management server 14. Upon completion of setup of a VLAN tag, the NIC 12 reports to the management board 13 that the setup of the VLAN tag has been completed.

In an operation stage of physical IaaS, (4) for a control command permitted for the host, the host transmits a control command to the NIC 12. According to the control command, the NIC 12 performs a process. Upon completion of the process, the NIC 12 reports to the host that the process has been completed.

In a withdrawing stage of physical IaaS, (5) to initialize a setting of the NIC 12, the management board 13 gives the NIC 12 an instruction to initialize NIC setting information 26 according to an instruction from the management server 14. According to the instruction, the NIC 12 initializes the NIC setting information 26. Upon completion of the initialization, the NIC 12 reports to the management board 13 that the initialization has been completed.

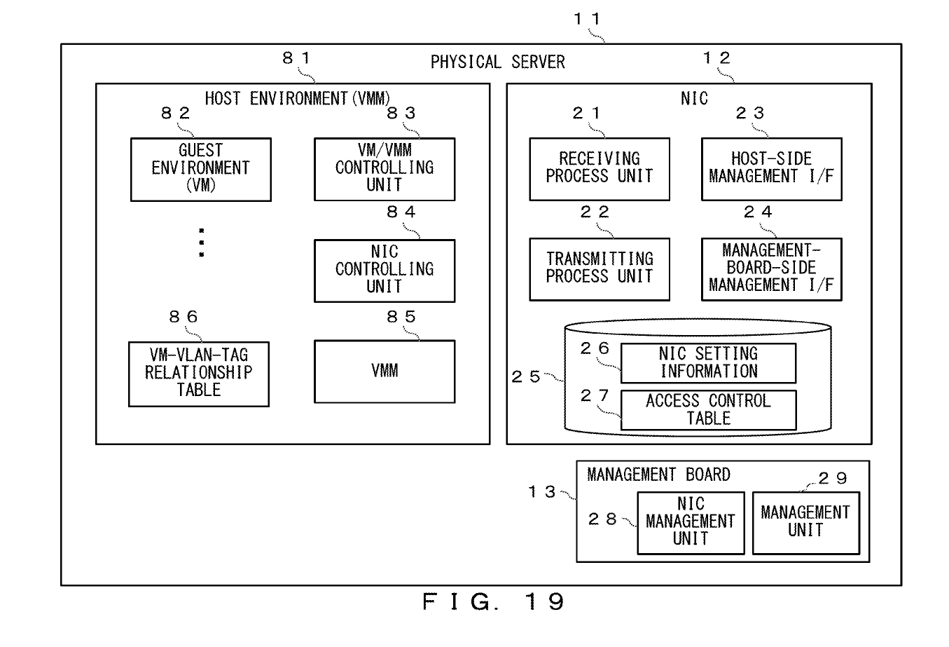

FIG. 18 illustrates an example of a frame sequence between hosts in accordance with the present embodiment (for physical IaaS). A host A1 transfers a frame to an NIC A1. The NIC A1 embeds a VLAN tag in a header of the frame transferred from the host A1. The NIC A1 transfers to a physical network the frame in which the VLAN tag has been embedded.

An NIC A2 receives the frame transmitted via the physical network. The NIC A2 determines whether or not the tag value of the VLAN tag of the received frame is identical with a tag value set for the NIC A2. When the tag value of the VLAN tag of the received frame is identical with the tag value set for the NIC A2, the NIC A2 removes the VLAN tag from the received frame and transfers to a host-B2-side the frame from which the VLAN tag has been removed.

<Virtual IaaS>

Next, an example will be described in regard to virtual IaaS. Note that components, processes, or functions that are the same as those in the physical IaaS environment already described above will be indicated using the same reference signs so that their descriptions can be omitted.

FIG. 19 illustrates an example of a physical server in accordance with the present embodiment (for virtual IaaS). A physical server 11 includes an NIC 12, a management board 13, and a host environment 81.

The host environment 81 of the physical server 11 is an environment virtualized via a virtualization technology. In the host environment 81, a plurality of virtual machines (VMs) are operated. Accordingly, the virtualization technology allows an operating system (OS) to be operated at each VM (guest environment) 82. As a result, the VM is operated in each guest environment 82 (82-1 and 82-2).

A VM/VMM controlling unit 83 generates a VM and controls an operation of a VMM while the VM is being generated. Meanwhile, the VM/VMM controlling unit 83 constructs a VLAN environment for the VM. In this case, the VM/VMM controlling unit 83 creates a VM-VLAN-tag relationship table to manage the VLAN environment for the VM. A VMM 85 controls an operation of the generated VM.

An NIC controlling unit 84 includes a virtual switch function that switches a network connection between VMs. The NIC controlling unit 84 includes a function that routes a frame toward a VM in accordance with a VLAN tag and according to a VM-VLAN-tag relationship table 86. The NIC controlling unit 84 also includes, for example, a function that embeds and deletes a VLAN tag.

The NIC 12 and the management board 13 are similar to those in the physical IaaS environment that were already described above. For the NIC setting information 26, the mask of “reception mask” 26-4 of “tag value” 26-3 corresponding to each VM is invalidated (x). The host-side management I/F 23 is a communication interface to communicate with the host (VMM) in relation to a control related to the NIC 12. The host-side management I/F 23 controls access from the host (VMM) according to the access control table 27.

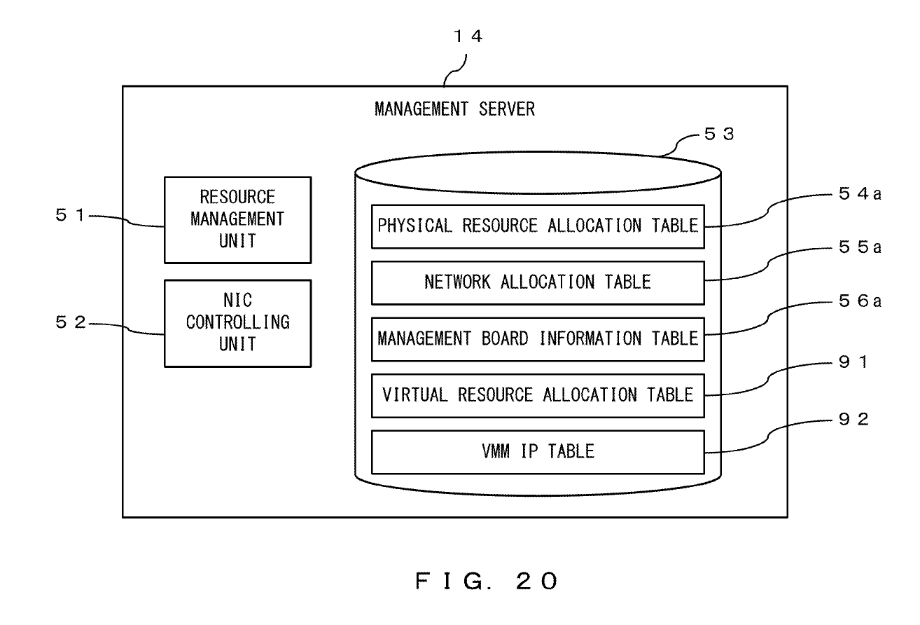

FIG. 20 illustrates an example of a management server in accordance with the present embodiment (for virtual IaaS). A management server 14 includes a resource management unit 51, an NIC controlling unit 52, and a storage unit 53. The resource management unit 51 and the NIC controlling unit 52 are similar to those in the physical IaaS environment that were already described above.

The storage unit 53 stores a physical resource allocation table 54a, a network allocation table 55a, a management board information table 56a, a virtual resource allocation table 91, and a VMM IP table 92.

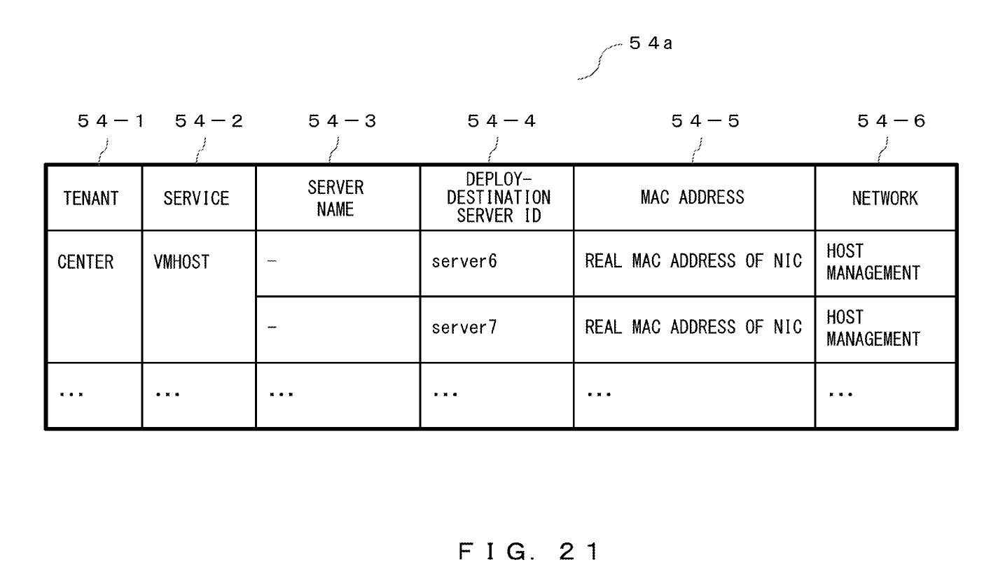

FIG. 21 illustrates an example of a physical resource allocation table in accordance with the present embodiment (virtual IaaS). Data items included in the physical resource allocation table 54a are the same as those in FIG. 8, so descriptions will not be given of these data items.

In the physical resource allocation table 54a, a center name is stored in “tenant” 54-1. “VMHOST”, which indicates that the physical server 11 that constructs the host environment 81 is a host of a VM, is stored in “service” 54-2. A real MAC address of an NIC provided at the physical server 11 that is a deploy destination is stored in “MAC address” 54-4.

Note that the physical resource allocation table 54a may include content from the physical resource allocation table 54 used for physical IaaS.

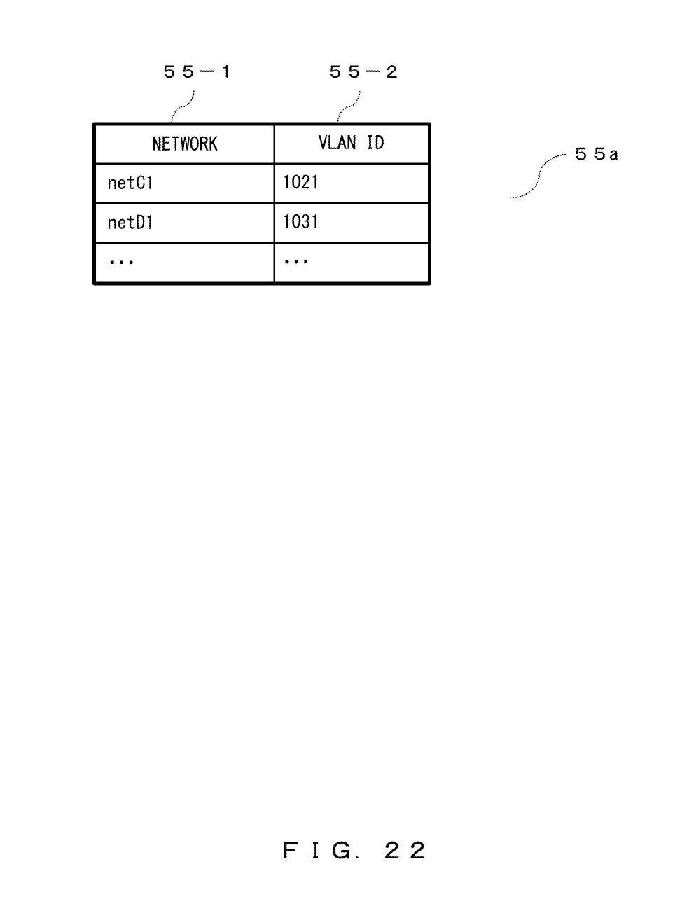

FIG. 22 illustrates an example of a network allocation table in accordance with the present embodiment (for virtual IaaS). Data items included in the network allocation table 55a are the same as those in FIG. 9, so descriptions will not be given of these data items.

Note that the network allocation table 55a may include content from the network allocation table 55 used for physical IaaS.

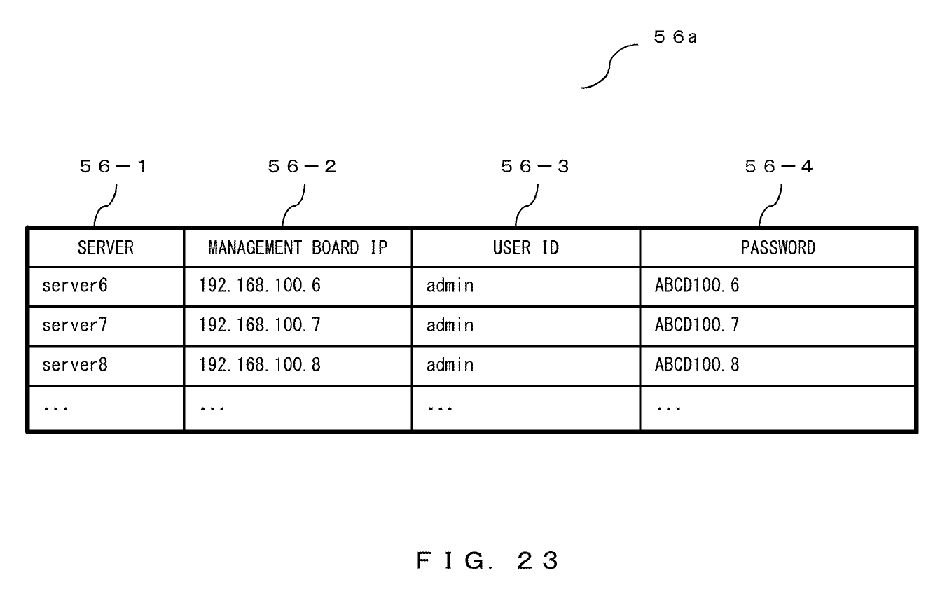

FIG. 23 illustrates an example of a management board information table in accordance with the present embodiment (for virtual IaaS). Data items included in the management board information table 56a are the same as those in FIG. 10, so descriptions will not be given of these data items. Server names of the physical servers 11 are stored in “server” 56-1.

Note that the management board information table 56a may include content from the management board information table 56 used for physical IaaS.

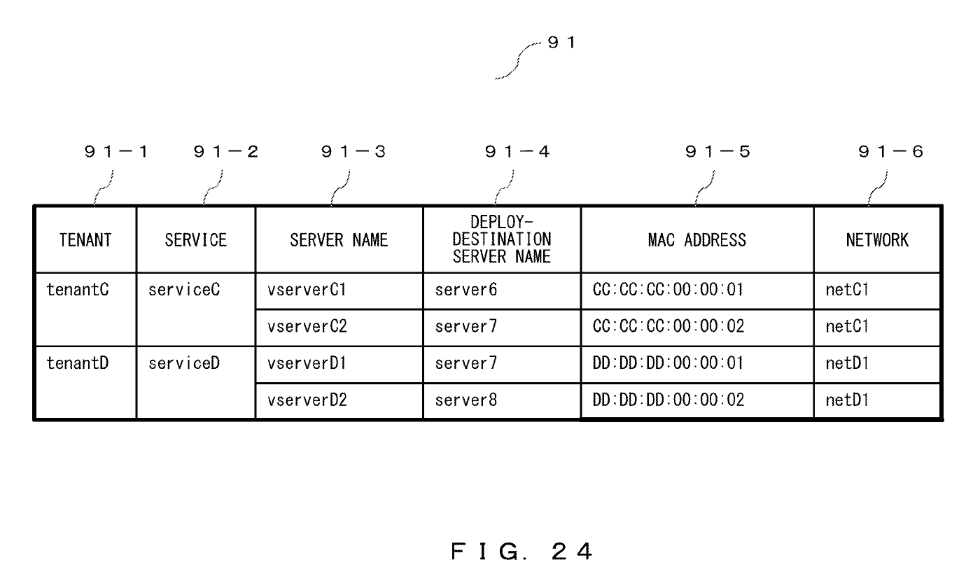

FIG. 24 illustrates an example of a virtual resource allocation table in accordance with the present embodiment (for virtual IaaS). A virtual resource allocation table 91 includes data headings of “tenant” 91-1, “service” 91-2, “server name” 91-3, “server ID” 91-4, “MAC address” 91-5, and “network” 91-6.

Tenant names are stored in “tenant”. The names of services used by the tenant are stored in “service” 91-2. The name of a server used by the tenant is stored in “server name” 54-3. Information for identifying a VM 82 used at the tenant is stored in “server name” 91-3. Information for identifying the physical server 11 that constructs the VM 82 is stored in “deploy-destination server name” 91-4. MAC addresses allocated to the VMs 82 are stored in “MAC address” 91-5. The name of a network (a VLAN) that forms a tenant to which the VM 82 belongs is stored in “network” 91-6.

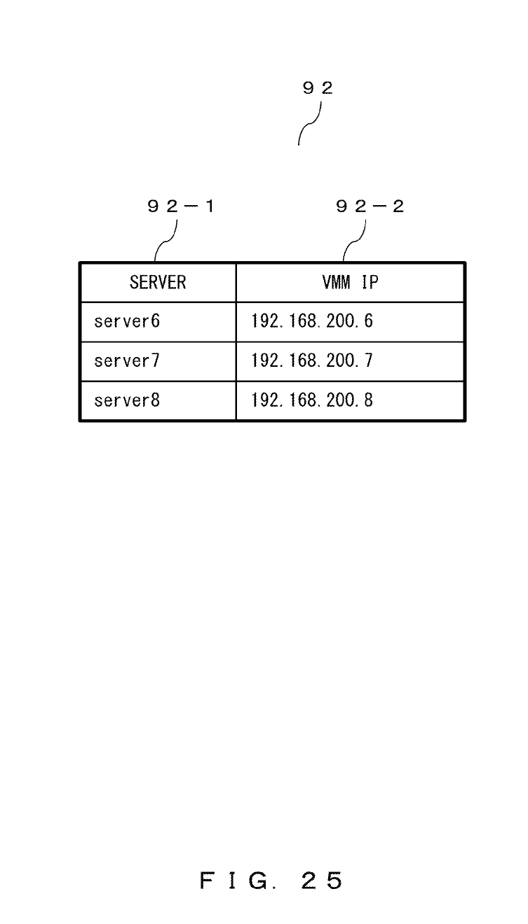

FIG. 25 illustrates an example of a VMM IP table in accordance with the present embodiment (for virtual IaaS). A VMM IP table 92 includes data items of “server” 92-1 and “VMM IP” 92-2.

Information for identifying the physical server 11 that constructs the VM 82 is stored in “server” 92-1. An IP (Internet Protocol) address for controlling a VMM introduced in the physical server 11 is stored in “VMM control IP” 92-2.

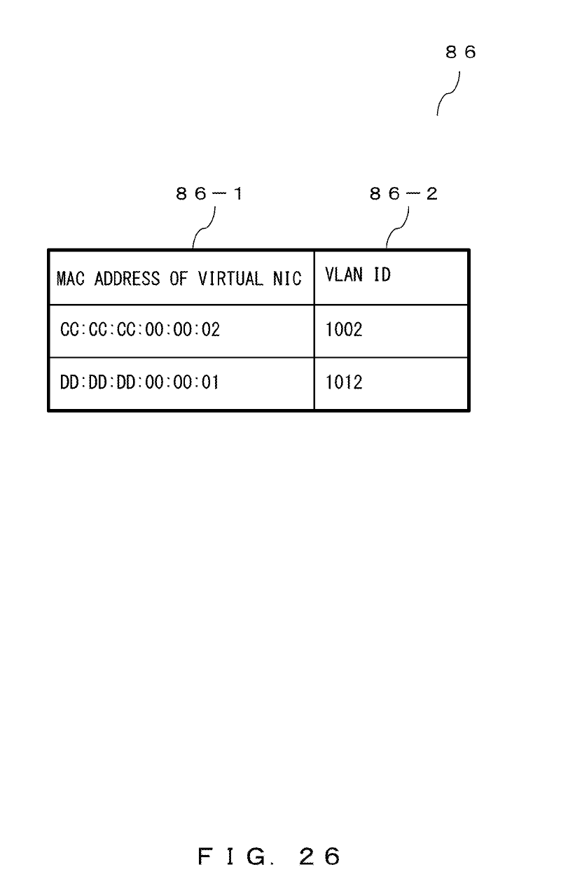

FIG. 26 illustrates an example of a VM-VLAN-ID relationship table in accordance with the present embodiment (for virtual IaaS). A VM-VLAN-ID relationship table 86 is created to construct a VLAN for a VM. The VM-VLAN-ID relationship table 86 includes data headings of “MAC address of virtual NIC” 86-1 and “VLAN ID” 86-2.

A MAC address of a virtual NIC of a virtual server (a VM) that is a transmission destination is stored in “MAC address of virtual NIC” 86-1. A VLAN ID (a tag value) for identifying a VLAN used by the VM is stored in “VLAN ID” 86-2.

Next, virtual IaaS will be described using further detailed examples.

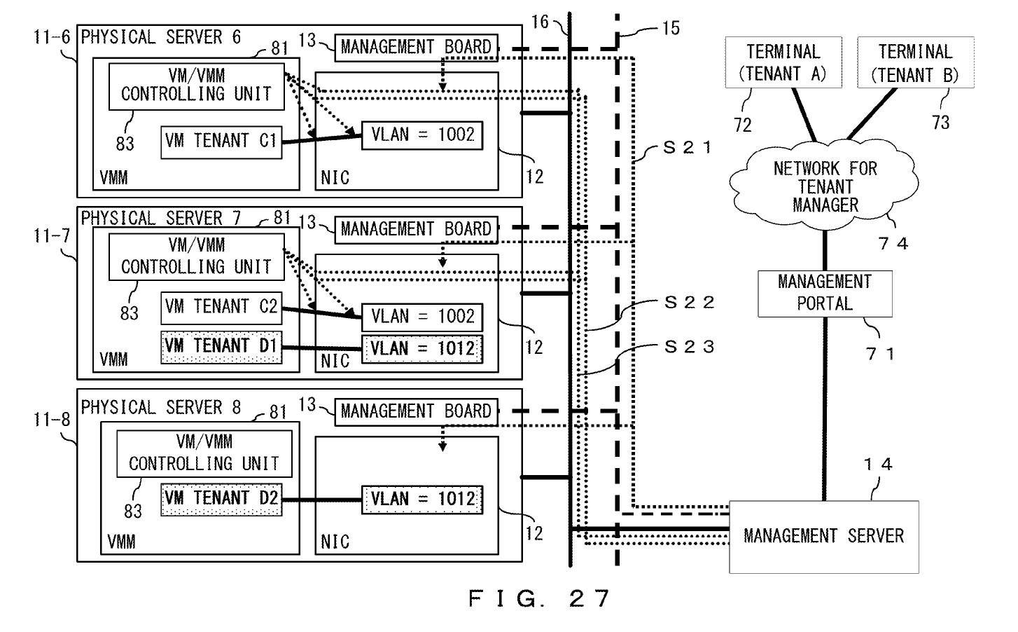

FIG. 27 illustrates an example of allocation of physical resources and virtual resources for each tenant in accordance with the present embodiment (for virtual IaaS). The virtual IaaS in FIG. 27 includes physical servers 6 to 8 (11-6 to 11-8), a management server 14, a portal server 71, a terminal A (72), and a terminal B (73). The physical servers 6 to 8 (11-6 to 11-8) are connected to the operational network 16 via the NIC 12. The physical servers 6 to 8 (11-6 to 11-8) are connected to the management network 15 via the management boards 13. The management server 14 is connected to the management network 15 and the operational network 16. The management server 14 is connected to the portal server 71.

The portal server 71 is connected to the terminal A (72) and the terminal B (73) via a network 74 for a tenant manager. The terminal A (72) is an information processing terminal used by a manager of a tenant A. The terminal B (73) is an information processing terminal used by a manager of a tenant B. The portal server 71 is a portal server of the physical IaaS. Using the terminal 72 or 73, the tenant manager allocates a resource to a target physical server 11 via the portal server 71.

As an example, using the terminal A (72), the manager of the tenant A gives an instruction to allocate the tenant C1 to the physical server 6 (11-6) and the tenant C2 to the physical server 7 (11-7).

Accordingly, the NIC controlling unit 52 of the management server 14 introduces VMMs in the physical server 6 (11-6) and the physical server 7 (11-7) via the management network 15 and the management board 13. As a result, host environments (VMMs) 81 are constructed in the physical servers 6 to 8 (11-6 to 11-8). In this case, the management server 14 sets “valid” in “via-host configuration” 26-1 of the NIC setting information 26 of the physical servers 6 to 8 (11-6 to 11-8) via the management network 15 and the management board 13 (S21).

Next, according to an instruction from the management server 14 transmitted via the operational network 16, the VM/VMM controlling unit 83 sets the VLAN tag=“1002” for the NIC 12 (S22). According to the instruction from the management server 14 transmitted via the operational network 16, the VM/VMM controlling unit 83 introduces a VM and allocates a tenant to this VM. According to the instruction from the management server 14 transmitted via the operational network 16, the VM/VMM controlling unit 83 sets up a path between the VM and a VLAN corresponding to the VM (S23).

As in the case of the tenant A, for the tenant B, a VMM is introduced in the physical server 11, information of NIC setting information 26 is set up, and a path is set up between a VM and a VLAN corresponding to the VM (S21 to S23).

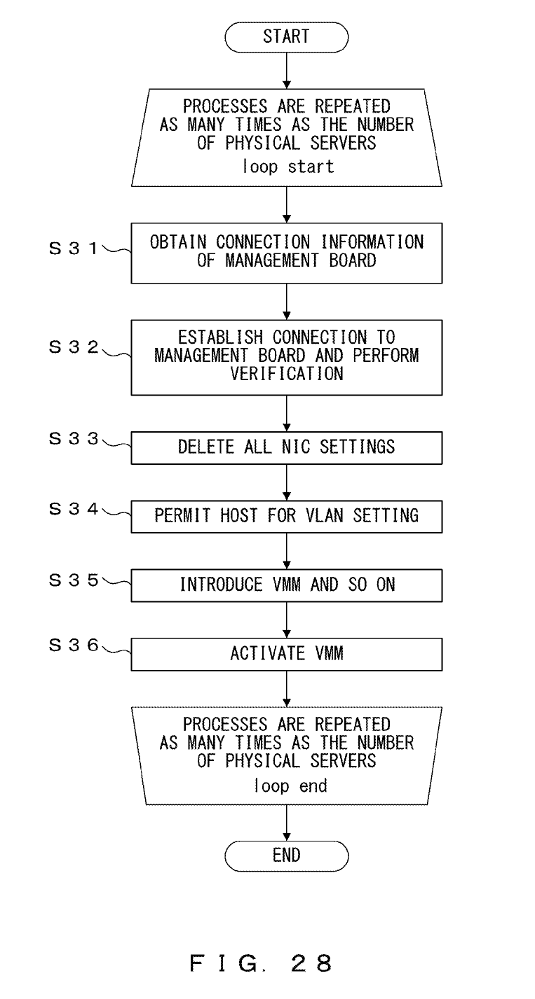

FIG. 28 illustrates an exemplary flow of an allocating process of allocating resources to a physical server performed by a management server in accordance with the present embodiment (for virtual IaaS). In the present embodiment, physical resources (e.g., a physical server and a network) and a virtual resource (a VMM) provided to a user are decided on in advance.

The management server 14 reads one record from the physical resource allocation table 54a. Using “deploy-destination server name” 54-4 of the read record as a key, the management server 14 obtains from the management board information table 56a management board information (a management board IP, a user ID, and a password) corresponding to the deploy-destination server name (S31).

The management server 14 establishes a connection to the management board 13 and transmits the user ID and the password to the management board 13 that corresponds to the management board IP of the obtained management board information. Using a user ID and a password registered in the management board 13 in advance, the management board 13 performs verification against the user ID and the password that have been transmitted (S32).

After the verification is performed by the management board 13, the management server 14 deletes (initializes), via the management board 13, the NIC setting information 26 of the NIC 12 provided at the physical server 11 that includes this management board 13 (S33).

The management server 14 transmits, via the management board 13, the setting information including setting items of NIC setting information 26, which will be described hereinafter, to the NIC 12 of the physical server 11 that includes this management board 13. In the NIC 12, upon receipt of the setting information, the management-board-side management I/F 24 sets up NIC setting information 26 according to the received setting information. In particular, the management-board-side management I/F 24 sets “valid” in “via-host configuration” of the NIC setting information 26 of the NIC 12 (S34). The management-board-side management I/F 24 sets “valid” in “reception filter” 26-2. The management-board-side management I/F 24 sets “valid” in “tagless reception” 26-5. The management-board-side management I/F 24 sets “valid” in “received-tag deletion” 26-6. The management-board-side management I/F 24 sets “invalid” in “transmission-tag embedding” 26-7. The management-board-side management I/F 24 sets a value of “MAC address” 29-11 in “allocation MAC address” 26-9. The management server 14 sets “invalid” in “promiscuous mode” 26-10.

The management server 14 introduces, for example, a VMM in the physical server 11 via the management board 13 (S35) and activates the VMM (S36).

The management server 14 repeats the processes of S31 to S36 as many times as the number of the physical servers 11 to which resources are allocated.

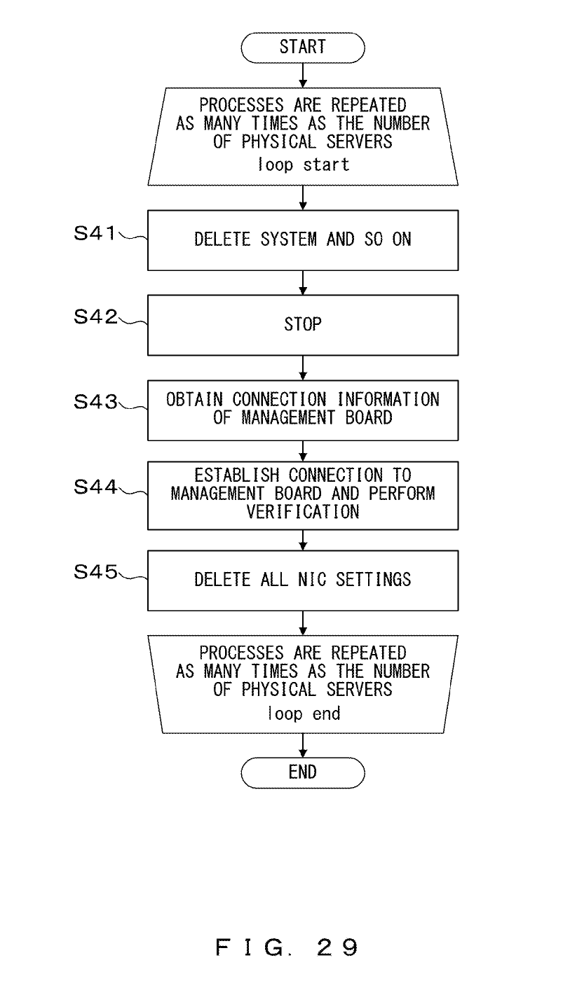

FIG. 29 illustrates an exemplary flow of a cancelling process of deallocation of resources of a physical server performed by the management server in accordance with the present embodiment (for virtual IaaS). Via the management board 13, the management server 14 performs a control on, for example, deletion of a VMM or another element of each physical server 11 (S41) and stops the physical server 11 (S42).

The management server 14 reads one record from the physical resource allocation table 54. Using “deploy-destination server name” 54-4 of the read record as a key, the management server 14 obtains from the management board information table 56a management board information (a management board IP, a user name, and a password) corresponding to the deploy-destination server name (S43).

The management server 14 establishes a connection to and transmits the user name and the password to the management board 13 that corresponds to the management board IP of the obtained management board information. Using a user name and a password registered in the management board 13 in advance, the management board 13 performs verification against the user name and the password that have been transmitted (S44).

After the verification is performed by the management board 13, the management server 14 gives, via the management board 13, an instruction to delete the NIC setting information 26 of the NIC 12 provided at the physical server 11 (S45). In the NIC 12, according to the instruction information, the management-board-side management I/F 24 deletes (initializes) the NIC setting information 26 from the storage unit 25.

The management server 14 repeats the processes of S41 to S45 as many times as the number of physical servers 11 for which allocation of resources is cancelled.

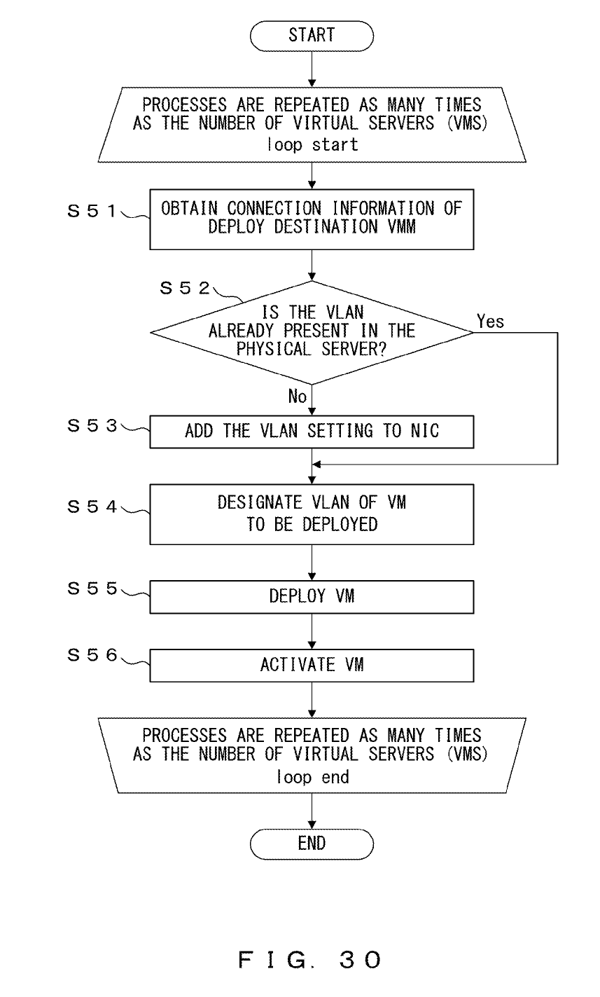

FIG. 30 illustrates an exemplary flow of an allocating process of allocating VMs to a physical server performed by a management server in accordance with the present embodiment (for virtual IaaS). In the present embodiment, resources related to a VM provided to users are decided on in advance.

The management server 14 reads one record from the virtual resource allocation table 91. Using “deploy-destination server name” 91-4 of the read record as a key, the management server 14 obtains from the VMM IP table 92 a VMM IP corresponding to the deploy-destination server name (S51). Moreover, using “network” 91-6 of the record read from the virtual resource allocation table 91 as a key, the management server 14 obtains from the network allocation table 55a a VLAN ID (a tag value) corresponding to the network name.

Using “deploy-destination server name” 91-4 and “network” 91-6 of the record read from the virtual resource allocation table 91, the management server 14 determines whether there is already an identical VLAN in the physical server (S52). The management server 14 may inquire of a VMM of the obtained VMM IP whether there is a VLAN that is identical with “network” 91-6 of the record read from the virtual resource allocation table 91.

When the identical VLAN is not present in the physical server (“No” in S52), the management server 14 performs the following process. The management server 14 gives a VMM of the VMM IP obtained in S51 an instruction to set the obtained VLAN tag value for the NIC 12. According to the instruction, in relation to the NIC setting information 26, the VM/VMM controlling unit 83 sets “o” in “reception mask” 26-4 of “tag value” 26-3 that corresponds to the VLAN tag value transmitted from the management server 14 (S53).

When the identical VLAN is not present in the physical server 11 (“Yes” in S52), the management server 14 transmits a VLAN tag value to the VMM IP obtained in S51.

The VM/VMM controlling unit 83 designates a VLAN of a VM to be deployed (S54). That is, the VM/VMM controlling unit 83 stores in the VM-VLAN-ID relationship table 86 information that associates the MAC address and the VLAN ID of the VM to be deployed with each other.

Using the VMM IP, the management server 14 gives the VMM an instruction to deploy the VM. Accordingly, the VMM deploys the VM (S55). In this case, the VMM sets up a path between the VM and a VLAN corresponding to the VM. After this, the VM is activated (S56).

The management server 14 and the VMM repeat the processes of S51 to S56 as many times as the number of VMs to which resources are allocated.

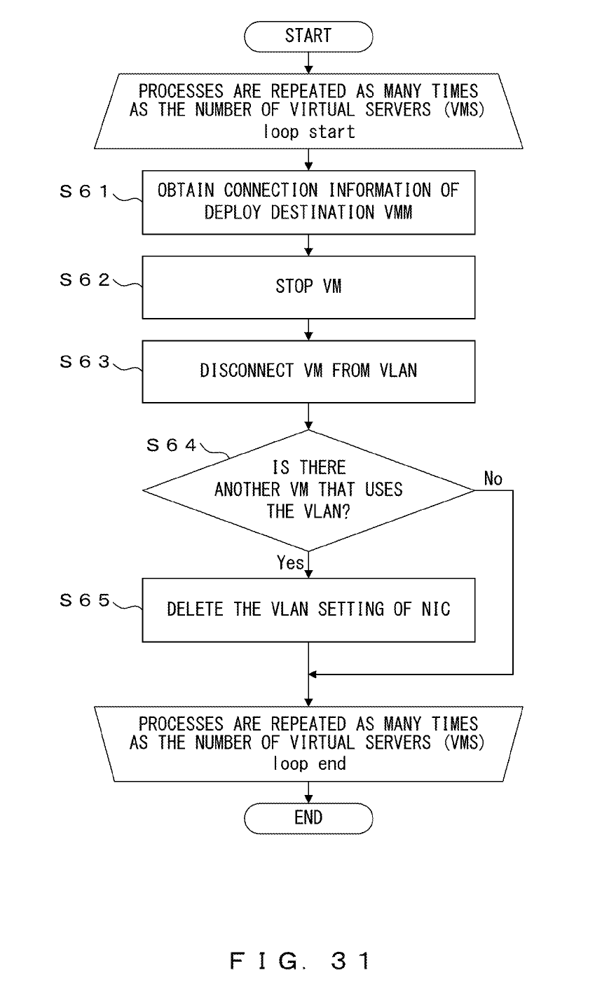

FIG. 31 illustrates an exemplary flow of a cancelling process of deallocation of VMs performed by the management server in accordance with the present embodiment (for virtual IaaS). The management server 14 reads one record from the virtual resource allocation table 91. Using “deploy-destination server name” 91-4 of the read record as a key, the management server 14 obtains from the VMM IP table 92 a VMM IP corresponding to the deploy-destination server name (S61).

Via the operational network 16 and using the VMM IP, the management server 14 gives the VMM an instruction to stop an operation of a VM. According to the instruction, the VMM stops the VM (S62).

Via the operational network 16, the management server 14 gives the VMM an instruction to disconnect the VM from a VLAN. According to the instruction, the VMM deletes from the VM-VLAN-ID relationship table 86 relationship information indicating a relationship between the MAC address and the VLAN ID of a virtual NIC of the VM (S63).

The VM/VMM controlling unit 83 of the VMM determines whether or not there is another VM that uses the VLAN indicated by the VLAN tag value (S64). When there is no other VM that uses the VLAN indicated by the VLAN tag value (“Yes” in S64), the VM/VMM controlling unit 83 performs the following process. That is, for the NIC setting information 26 of the NIC 12, the VM/VMM controlling unit 83 sets “x” in “reception mask” 26-4 of “tag value” 26-3 that corresponds to the deleted VLAN tag value (S65).

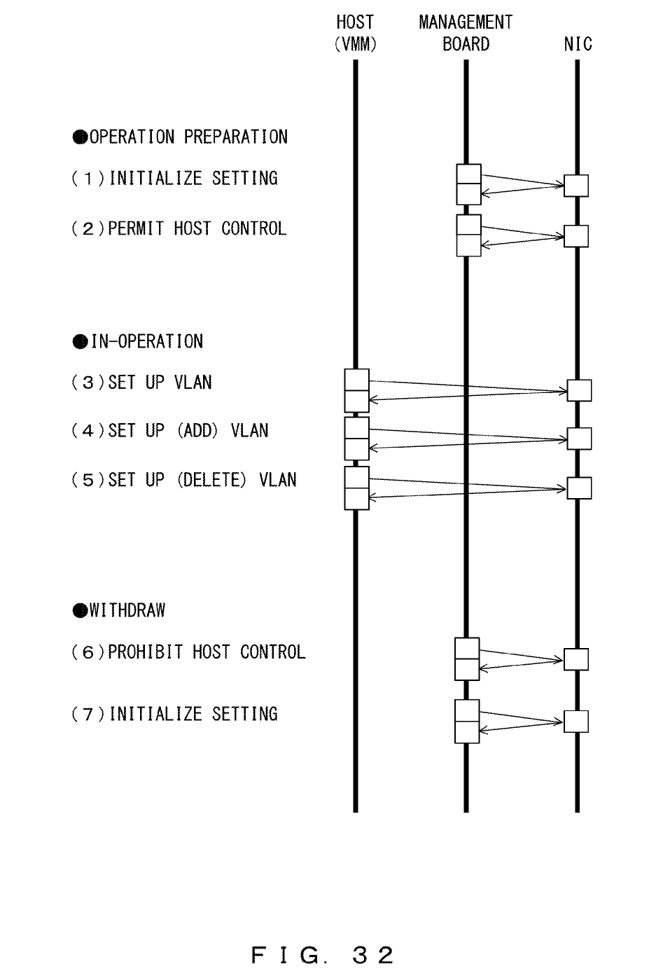

FIG. 32 illustrates an example of a command sequence between a host, a management board, and an NIC in accordance with the present embodiment (for virtual IaaS). In an operation preparation stage of virtual IaaS, (1) to initialize a setting of an NIC, the management board 13 gives the NIC 12 an instruction to initialize NIC setting information 26 according to an instruction from the management server 14. According to the instruction, the NIC 12 initializes the NIC setting information 26. Upon completion of the initialization, the NIC 12 reports to the management board 13 that the initialization has been completed.

In the operation preparation stage of virtual IaaS, (2) to allow a host (a VMM) to control the NIC 12, the management board 13 gives the NIC 12 an instruction to “validate” “via-host configuration” 26-1 of the NIC setting information 26 according to an instruction from the management server 14. According to the instruction, the NIC 12 sets “valid” in “via-host configuration” 26-1 of the NIC setting information 26. Upon completion of updating of the NIC setting information 26, the NIC 12 reports to the management board 13 that the updating of the NIC setting information 26 has been completed.

In the operation stage of virtual IaaS, (3) to set up a VLAN, the host (the VMM) gives the NIC 12 an instruction to set a tag value designated by the management server 14 in the NIC setting information 26. According to the instruction, the NIC 12 sets “o” in “reception mask” 26-4 of “tag value” 26-3 that corresponds to the tag value designated by the host (the VMM). Upon completion of setup of a VLAN tag, the NIC 12 reports to the host (the VMM) that the setup of the VLAN tag has been completed.

In the operation stage of virtual IaaS, (4) to add a VLAN, the host (the VMM) gives the NIC 12 an instruction to set a tag value designated by the management server 14 in NIC setting information 26. According to the instruction, the NIC 12 sets “o” in “reception mask” 26-4 of “tag value” 26-3 that corresponds to the tag value designated by the host (the VMM). Upon completion of the addition of the VLAN tag, the NIC 12 reports to the host (the VMM) that the addition of the VLAN tag has been completed.

In the operation stage of virtual IaaS, (5) to delete a VLAN, i.e., to disconnect a VM from the VLAN, the host (the VMM) gives the NIC 12 an instruction to delete the VLAN. According to the instruction, the NIC 12 sets “x” in “reception mask” 26-4 of “tag value” 26-3 that corresponds to the tag value designated by the host (the VMM). Upon completion of the deletion of the VLAN tag, the NIC 12 reports to the host (the VMM) that the deletion of the VLAN tag has been completed.

In a withdrawing state of virtual IaaS, (6) to prohibit the host from controlling the NIC 12, the management board 13 gives the NIC 12 an instruction to “invalidate” “via-host configuration” 26-1 of NIC setting information 26 according to an instruction from the management server 14. According to the instruction, the NIC 12 sets “invalid” in “via-host configuration” 26-1 of the NIC setting information 26. Upon completion of the updating of the NIC setting information 26, the NIC 12 reports to the management board 13 that the updating of the NIC setting information 26 has been completed.

In the withdrawing stage of virtual IaaS, (7) to initialize a setting of an NIC, the management board 13 gives the NIC 12 an instruction to initialize NIC setting information 26 according to an instruction from the management server 14. According to the instruction, the NIC 12 initializes the NIC setting information 26. Upon completion of the initialization, the NIC 12 reports to the management board 13 that the initialization has been completed.

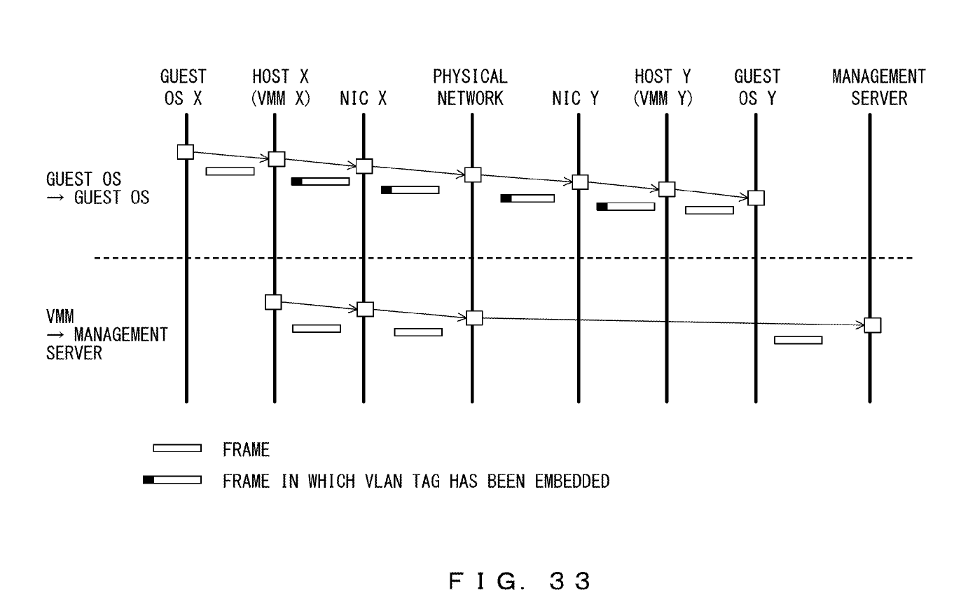

FIG. 33 illustrates an exemplary frame sequence between guest OSs and an exemplary frame sequence between a VMM and a management server in accordance with the present embodiment (for virtual IaaS).

First, the frame sequence between guest OSs will be described. A guest OS X transfers data to a host X (a VMM). The host X (the VMM) embeds a VLAN tag in a frame header of the data transferred from the guest OS X. Via an NIC X, the host X (the VMM X) transfers to a physical network a frame in which the VLAN tag has been embedded.

An NIC Y receives the frame that has been transmitted via the physical network. The NIC Y transfers the frame to a host Y (a VMM Y). The host Y (VMM Y) determines whether the tag value of the VLAN tag of the frame is registered in the VM-VLAN-ID relationship table 86. When the tag value of the VLAN tag of the frame is registered in the VM-VLAN-ID relationship table 86, the host Y (the VMM Y) deletes the VLAN tag from the frame. Using the VM-VLAN-ID relationship table 86, the host Y (the VMM Y) transfers the frame from which the VLAN tag has been deleted to a VM (a guest OS) indicated by the MAC address of the virtual NIC that corresponds to the VLAN tag value.

Next, the frame sequence between a VMM and a management server will be described. The VMM transmits a data-containing frame addressed to the management server 14. The NIC X transfers to the physical network the frame transmitted from the VMM. The management server 14 receives the frame transmitted via the physical network.

<Processes Common Between Physical IaaS and Virtual IaaS>

Next, processes commonly used for physical IaaS and virtual IaaS will be described.

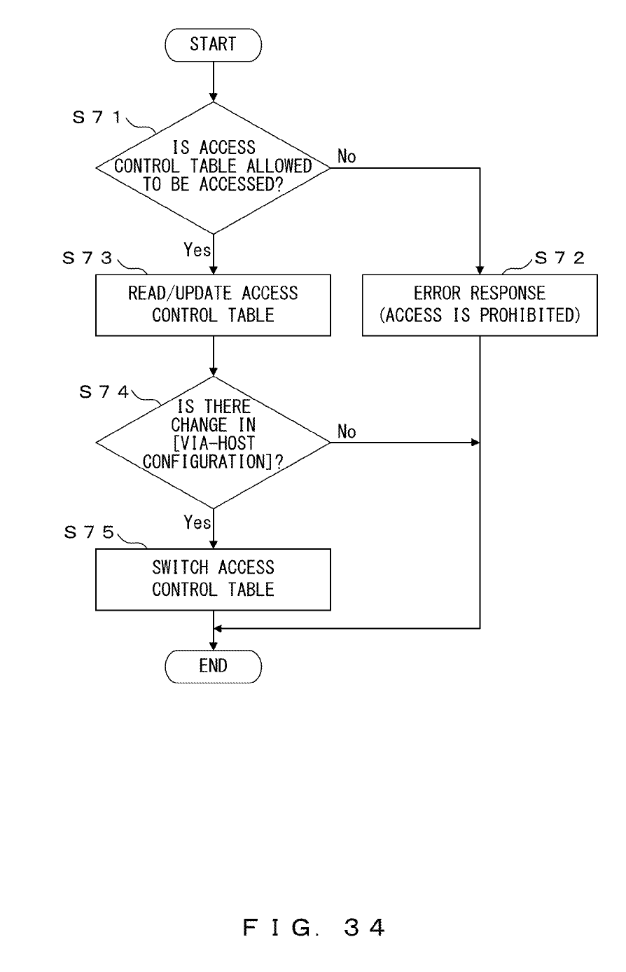

FIG. 34 illustrates an exemplary process flow of an NIC with respect to access from a management board in accordance with the present embodiment (for physical IaaS and virtual IaaS). Assume that the NIC management unit 28 of the management board 13 attempts to access the access control table 27 provided at the NIC 12 via the management-board-side management I/F 16.

When there is access from the NIC management unit 28, the management-board-side management I/F 24 of the NIC 12 references the access control table 27 and determines whether or not access to each setting item of NIC setting information 26 is permitted (S71). When access to the access control table 27 is prohibited (“No” in S71), the management-board-side management I/F 24 transmits an error response to the NIC management unit 28 (S72).

When access to the access control table 27 is permitted (“Yes” in S71), the management-board-side management I/F 24 performs the following process. That is, in accordance with an access limitation that is set in the access control table 27 (an access limitation on access to the setting items included in NIC setting information 26), the management-board-side management I/F 24 reads or updates the setting items included in NIC setting information 26 (S73).

When there is a change in a setting of “via-host configuration” 26-1 as a result of the updating of NIC setting information 26 (“Yes” in S74), the management-board-side management I/F 24 switches the access limitation of the access control table 27 (S75). As an example, when “via-host configuration” 26-1 is updated to “invalid”, the management-board-side management I/F 24 switches the access limitation of the access control table 27 to a content indicated by reference code 63. As another example, when “via-host configuration” 26-1 is updated to “valid”, the management-board-side management I/F 24 switches the access limitation of the access control table 27 to a content indicated by reference code 66.

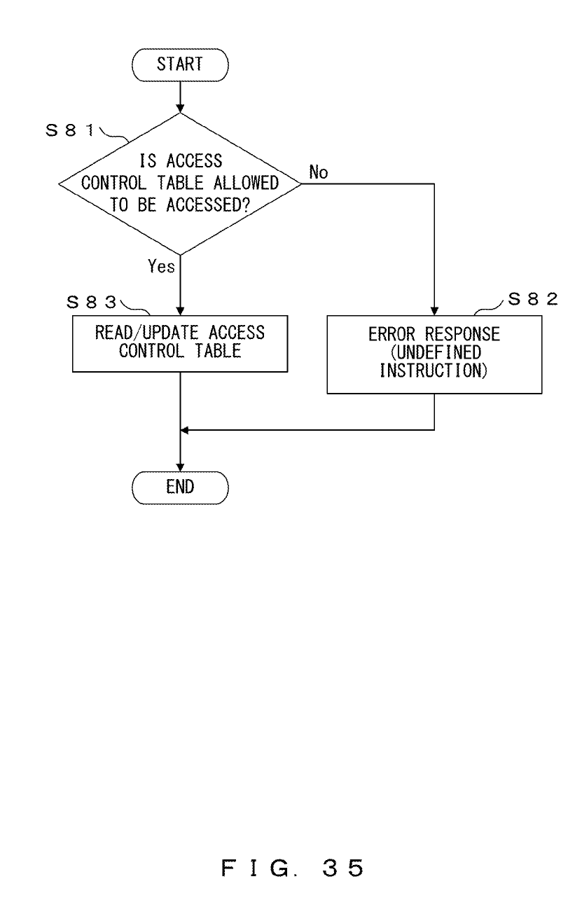

FIG. 35 illustrates an exemplary process flow of an NIC with respect to access from a host in accordance with the present embodiment (for physical IaaS and virtual IaaS). A host in the physical IaaS indicates an OS set up in the physical server 11, and a host in the virtual IaaS indicates a VMM. Assume that a host attempts to access the access control table 27 provided at the NIC 12 via the host-side management I/F 15.

When there is access from the NIC management unit 28, the host-side management I/F 23 of the NIC 12 references the access control table 27 and determines whether or not access to each setting item of NIC setting information 26 is permitted (S71). When access to the access control table 27 is prohibited (“No” in S81), the host-side management I/F 23 transmits an error response to the host (S82).

When access to the access control table 27 is permitted (“Yes” in S81), the host-side management I/F 23 performs the following process. That is, in accordance with an access limitation that is set in the access control table 27 (an access limitation on access to the setting items included in NIC setting information 26), the management-board-side management I/F 24 reads or updates the setting items included in NIC setting information 26 (S83).

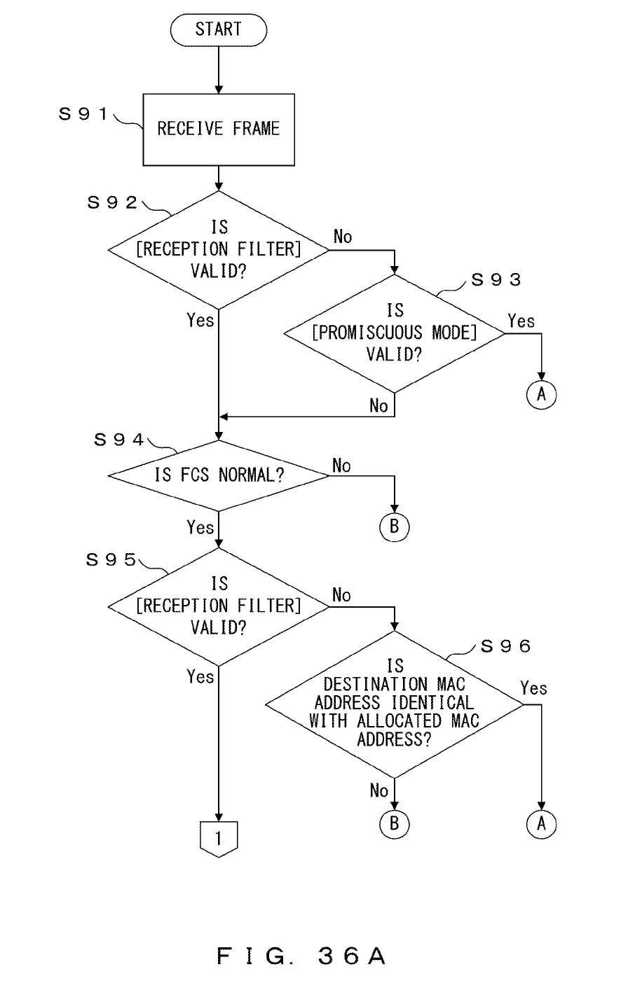

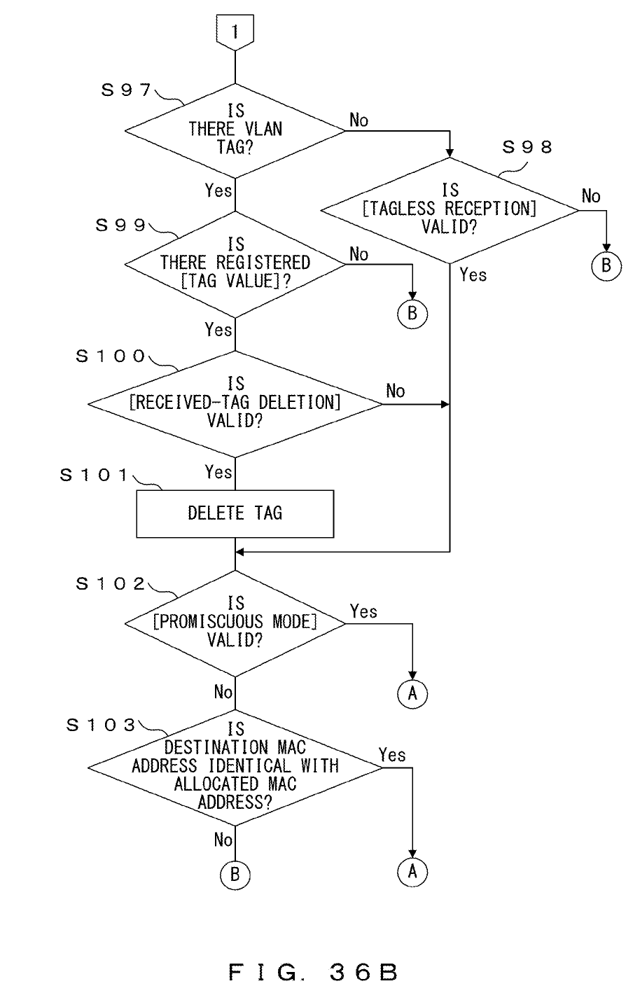

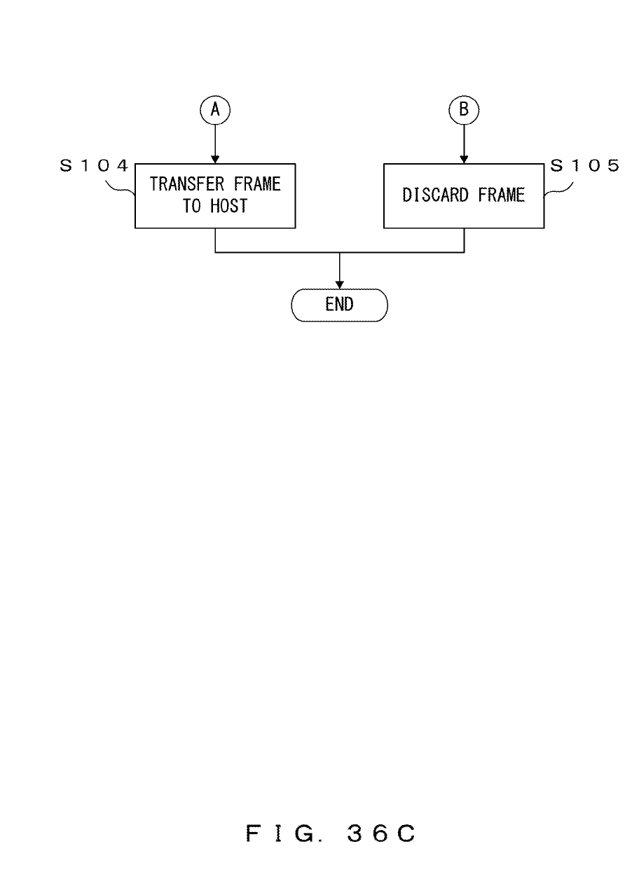

FIG. 36A, FIG. 36B, and FIG. 36C illustrate an exemplary flow of a receiving process of receiving a frame performed by an NIC in accordance with the present embodiment (for physical IaaS and virtual IaaS). In the NIC 12 of the physical server 11, the receiving process unit 21 (the signal receiving unit 31) receives a frame (S91). The receiving process unit 21 determines whether or not “valid” is set in “reception filter” 26-2 of NIC setting information 26 (S92).

When “invalid” is set in “reception filter” 26-2 (“No” in S92), the receiving process unit 21 determines whether or not “valid” is set in “promiscuous mode” 26-10 (S93). When “valid” is set in “promiscuous mode” 26-10 (“Yes” in S93), the receiving process unit 21 (the host-side reception I/F 36) transfers the frame to a host (S104).

When “valid” is set in “reception filter” 26-2 (“Yes” in S92) or when “invalid” is set in “promiscuous mode” 26-10 (“No” in S93), the receiving process unit 21 (the FCS verifying unit 32) performs the following process. That is, the FCS verifying unit 32 verifies a frame check sequence (FCS) of the received frame (S94). When the frame check sequence (FCS) is not correct as a result of the verifying of this sequence (“No” in S94), the receiving process unit 21 discards the frame (S105).

The receiving process unit 21 again determines whether or not “valid” is set in “reception filter” 26-2 (S95). When “valid” is set in “reception filter” 26-2 (“No” in S95), the receiving process unit 21 (the destination MAC confirming unit 33) performs the following process. That is, the receiving process unit 21 (the destination MAC confirming unit 33) determines whether the destination MAC address of the received frame is identical with “allocated MAC address” 26-9 of the NIC setting information 26 which the NIC has (S96).

When the destination MAC address of the received frame is identical with “allocated MAC address” 26-9 (“Yes” in S96), the receiving process unit 21 (the host-side reception I/F 36) transfers the frame to the host (S104).

When the destination MAC address of the received frame is not identical with “allocated MAC address” 26-9 (“No” in S96), the receiving process unit 21 discards the frame (S105).

When “valid” is set in “reception filter” 26-2 (“Yes” in S95), the receiving process unit 21 (the VLAN ID confirming unit 34) determines whether or not a VLAN tag is present in the received frame (S97).

When a VLAN tag is not present in the received frame (“No” in S97), it is determined whether or not “valid” is set in “tagless reception” 26-5 (S98). When “invalid” is set in “tagless reception” 26-5 (“No” in S98), the receiving process unit 21 discards the frame (S105).

When “valid” is set in “tagless reception” 26-5 (“Yes” in S98), the process shifts to S102.

When a VLAN tag is present in the received frame (“Yes” in S97), the receiving process unit 21 (the VLAN ID confirming unit 34) determines whether or not “o” is set in “reception mask” 26-4 of “tag value” 26-3 that corresponds to the tag value indicated by the VLAN tag (S99).

When “x” is set in “reception mask” 26-4 of “tag value” 26-3 that corresponds to the tag value indicated by the VLAN tag (“No” in S99), the receiving process unit 21 discards the frame (S105).

When “o” is set in “reception mask” 26-4 of “tag value” 26-3 that corresponds to the tag value indicated by the VLAN tag (“Yes” in S99), the receiving process unit 21 (the tag deleting unit 35) determines whether or not “valid” is set in “received-tag deletion” 26-6 (S100). When “valid” is set in “received-tag deletion” 26-6 (“Yes” in S100), the receiving process unit 21 (the tag deleting unit 35) deletes the VLAN tag from the received frame (S101).

After the VLAN tag is deleted from the received frame or when “invalid” is set in “received-tag deletion” 26-6 (“No” in S100), the receiving process unit 21 performs the following process. That is, the receiving process unit 21 determines whether or not “valid” is set in “promiscuous mode” 26-10 (S102).

When “valid” is set in “promiscuous mode” 26-10 (“Yes” in S102), the receiving process unit 21 (the host-side reception I/F 36) transfers the frame to the host (S104).

When “invalid” is set in “promiscuous mode” 26-10 (“No” in S102), the receiving process unit 21 (the destination MAC confirming unit 33) performs the following process. That is, the receiving process unit 21 (the destination MAC confirming unit 33) determines whether the destination MAC address of the received frame is identical with “allocated MAC address” 26-9 of the NIC setting information 26 which the NIC has (S103).

When the destination MAC address of the received frame is identical with “allocated MAC address” 26-9 (“Yes” in S103), the receiving process unit 21 (the host-side reception I/F 36) transfers the frame to the host (S104).

When the destination MAC address of the received frame is not identical with “allocated MAC address” 26-9 (“No” in S103), the receiving process unit 21 discards the frame (S105).

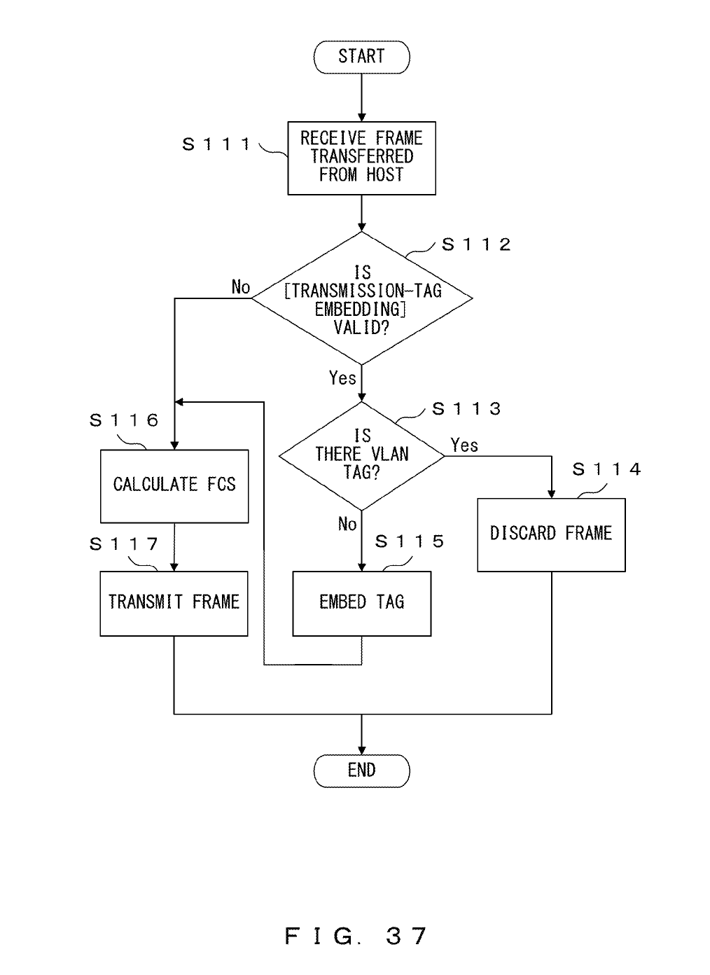

FIG. 37 illustrates an exemplary flow of a transmitting process of transmitting a frame performed by an NIC in accordance with the present embodiment (for physical IaaS and virtual IaaS). In the NIC 12, the transmitting process unit 22 (the host-side transmission I/F 45) receives a frame transmitted from a host (S111). The transmitting process unit 22 (the tag embedding unit 44) determines whether or not “valid” is set in “transmission-tag embedding” 26-7 of NIC setting information 26 (S112).

When “valid” is set in “transmission-tag embedding” 26-7 (“Yes” in S112), the transmitting process unit 22 (the tag embedding unit 44) determines whether or not a VLAN tag is present in the received frame (S113). When a VLAN tag is present in the received frame (“Yes” in S113), the transmitting process unit 22 discards the frame (S114). When a VLAN tag is not present in the received frame (“No” in S113), the transmitting process unit 22 (the tag embedding unit 44) embeds, as a VLAN tag, a value set in “transmission-tag value” 26-8 in the frame (S115).

When “invalid” is set in “transmission-tag embedding” 26-7 (“No” in S112) or when the embedding of a tag is completed (S115), the transmitting process unit 22 (the FCS calculating unit 42) performs the following process. That is, the transmitting process unit 22 (the FCS calculating unit 42) calculates a frame check sequence of the frame and adds the calculated value to the frame as FCS information (S116). The transmitting process unit 22 (the signal transmitting unit 41) then transmits the frame (S117).

In the present embodiment (physical IaaS and virtual IaaS), the NIC 12 is set up via the management board 13, but the present embodiment is not limited to this. As an example, the NIC 12 is provided with a function that detects a predetermined header. In the transmitting of setting information to the NIC 12, the management server 14 transmits information to which the predetermined header has been added. When the NIC 12 receives the information and detects the header, the NIC 12 may extract the setting information from the received information and may set this extracted setting information as NIC setting information.

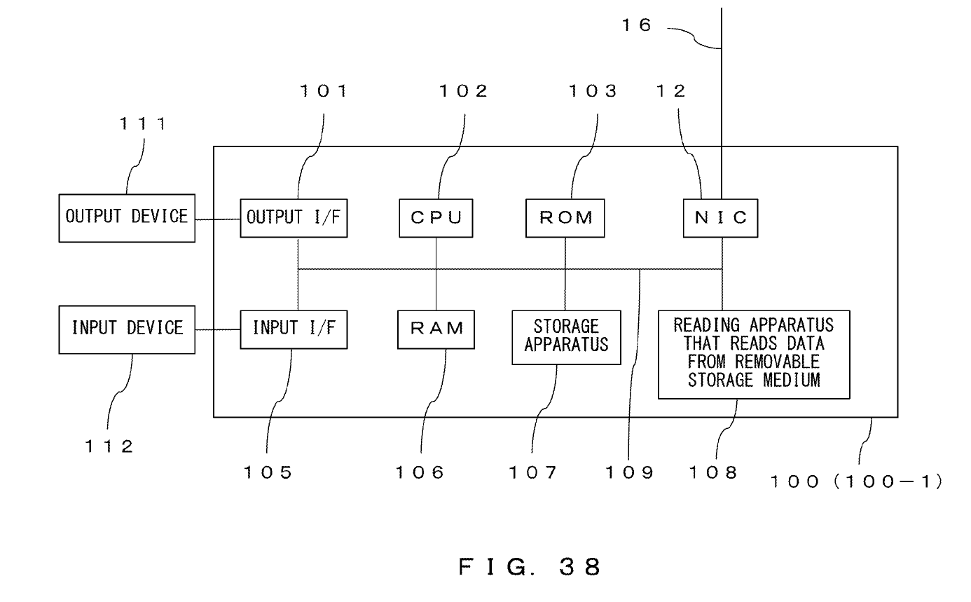

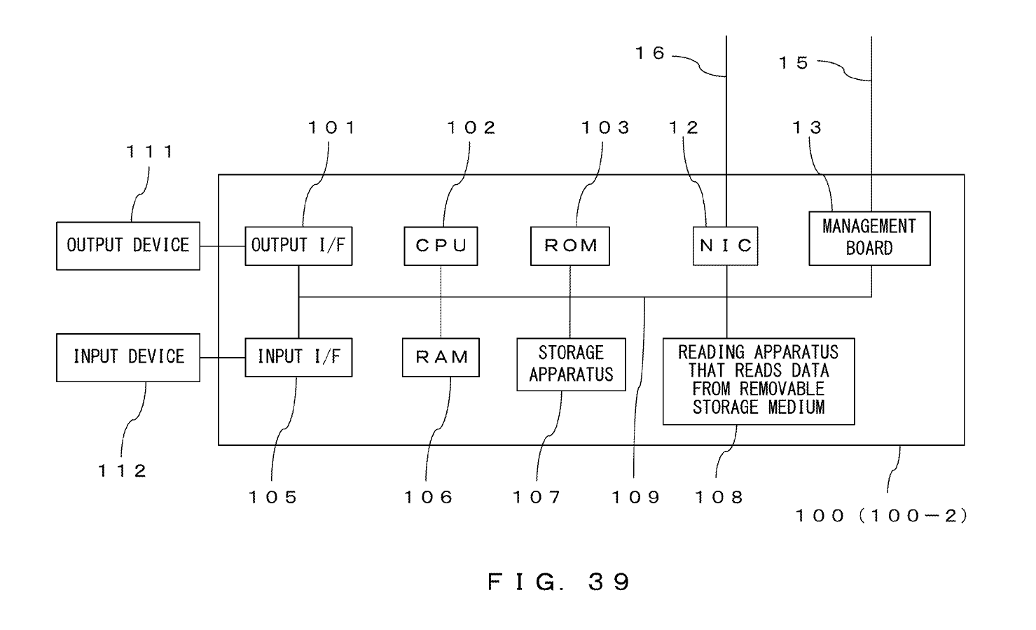

FIG. 38 and FIG. 39 illustrate an example of a configuration block diagram of a hardware environment of a computer to which the present embodiment has been applied. A computer 100-2 in FIG. 39 is the same as a computer 100-1 in FIG. 39 to which a management board 13 has been further added.

The computer 100 (100-1, 100-2) includes an output I/F 101, a CPU 102, a ROM 103, an NIC 12, an input I/F 105, a RAM 106, a storage apparatus 107, a reading apparatus 108, and a bus 109. The computer 100-2 further includes the management board 13. The computer 100 is connectable to an output device 111 and an input device 112.

The CPU indicates a central processing unit. The ROM indicates a read only memory. The RAM indicates a random access memory. The bus 109 is connected to the output I/F 101, the CPU 102, the ROM 103, the NIC 12, the input I/F 105, the RAM 106, the storage apparatus 107, and the reading apparatus 108. For the computer 100-2, the bus 109 is further connected to the management board 13. The reading apparatus 108 reads data from a removable recording medium. The output device 111 is connected to the output I/F 101. The input device 112 is connected to the input I/F 105.

Various forms of storage apparatuses such as a hard disk drive, a flash memory apparatus, and a magnetic disk apparatus may be used as the storage apparatus 107.

When the computer 100-1 serves as the management server 14, the storage apparatus 107 or the ROM 103 stores, for example, programs, data, and tables that implement the processes described with reference to the present embodiment. As the tables, the storage apparatus 107 or the ROM 103 stores, for example, the physical resource allocation table 54a, the network allocation table 55a, the management board information table 56a, the virtual resource allocation table 91, and the VMM IP table 92.

When the computer 100-2 serves as the physical server 11, the storage apparatus 107 or the ROM 103 stores, for example, programs, data, and tables that achieve a virtualization for implementing the processes described with reference to the present embodiment.

The CPU 102 reads a program stored in, for example, the storage apparatus 107 for implementing the processes described with reference to the present embodiment and executes this program.

When the computer 100-2 serves as the physical server 11, a storage apparatus provided for the NIC 12 stores, for example, NIC setting information 27, the access control table 27, and a program that implements the processes described with reference to the present embodiment.

The program that implements the processes described with reference to the present embodiment may be transmitted from the program-provider side via a communication network and may be stored in a storage apparatus provided for, for example, the NIC 12 or the management board 13. The program that implements the processes described with reference to the present embodiment may be stored in a commercially available removable recording medium. In this case, the removable recording medium may be set on the reading apparatus 108, and the CPU 102 may read and execute the program. Various forms of storage media such as a CD-ROM, a flexible disk, an optical disk, a magnet optical disk, an IC (integrated circuit) card, and a USB (Universal Serial Bus) memory apparatus may be used as the removable recording medium. A program stored in such a storage medium is read by the reading apparatus 108.

A keyboard, a mouse, an electronic camera, a web camera, a microphone, a scanner, a sensor, a tablet, a touch panel, and so on may be used as the input device 112. A display, a printer, a speaker, and so on may be used as the output device 111. The management network 15 and the operational network 16 may be communication networks such as the internet, a LAN (Local Area Network), a WAN (Wide Area Network), a private line network, a wired line network, and a wireless line network.

The communication interface apparatus in accordance with the present embodiment allows a separation of a network for each user to be secured without using a switch apparatus. That is, filtering of a VLAN may be controlled via an external apparatus so that a server manager can set up and manage the VLAN in addition to setting up and managing a server without aid from a network manager. That is, the server manager may make a setting of an NIC, i.e., a setting of a VLAN, as one server setting.

A control, such as dynamically setting up of a VLAN, is not performed on the switch apparatus side, so an independence of a virtual network for each user may be achieved without controlling the physical network side. In addition, a switch apparatus adapted to a VLAN is not used, so an increase in the cost of a network environment may be suppressed. In physical IaaS, operations performed on an NIC by a host may be limited. As a result, a physical server may be independent from the network.

In physical IaaS, all of the controls on a host are grasped by a user for whom the server is provided, and hence it is impossible to force the user to set up a VLAN. However, in accordance with the present embodiment, a VLAN for an NIC may be setup from outside without a control from the host side, so the user does not need to be forced to set up the VLAN.

The physical resource allocation table, the network allocation table, and the management board information table may include both data adapted to physical IaaS and data adapted to virtual IaaS, so data management does not need to be performed by separating the data adapted to physical IaaS and the data adapted to virtual IaaS from each other. Accordingly, resources for all data may be saved. Also, in the NIC, by switching the item of “via-host configuration” 26-1, the NIC in accordance with the present embodiment may be used for both physical IaaS and virtual IaaS. That is, while both physical IaaS and virtual IaaS are used, an independence, i.e., safety, of a network for each user may be enhanced.

In virtual IaaS, a filtering process may be performed by the NIC 12 at a stage that precedes a filtering process performed by the NIC controlling unit 84 of a virtual host, thereby decreasing loads caused by the filtering process performed by the NIC controlling unit 84 of the virtual host.

The communication interface apparatus in accordance with the present embodiment allows a separation of a network for each user to be secured in a server management region.

The present embodiment is not limited to the aforementioned embodiments. Various configurations or embodiments may be achieved without departing from the spirit of the present embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication interface apparatus provided at a first information processing apparatus, the communication interface apparatus comprising:
a setting information obtaining unit configured to obtain setting information from a second information processing apparatus that is different from the first information processing apparatus, the setting information including a piece of virtual network identification information corresponding to a virtual network to which the first information processing apparatus belongs from among pieces of virtual network identification information for identifying virtual networks;
a setup unit configured to set up the virtual network identification information according to the obtained setting information;
a receiving unit configured to receive data from a communication network;
a filtering unit configured to apply a filtering process to the received data according to the virtual network identification information that has been set up; and
a transferring unit configured to transfer to the first information processing apparatus the data to which the filtering process has been applied.

2. The communication interface apparatus according to claim 1, wherein
the filtering unit determines whether header information of the received data includes the virtual network identification information, and
when the header information includes the virtual network identification information, the filtering unit determines whether the virtual network identification information of the header information is identical with the virtual network identification information that has been set up.

3. The communication interface apparatus according to claim 2, wherein
when the virtual network identification information of the header is determined to be identical with the virtual network identification information that has been set up, the transferring unit transfers to the first information processing apparatus data that is the header information from which the virtual network identification information has been removed.

4. The communication interface apparatus according to claim 2, wherein
the filtering unit further determines whether a destination address of the header of the received data is identical with an address set for the communication interface apparatus.

5. The communication interface apparatus according to claim 1, the communication interface apparatus further comprising:
an adding unit configured to add the virtual network identification information that has been set up to header information of data received from the first information processing apparatus; and
a transmitting unit configured to transmit to the communication network the data to which the virtual network identification information has been added.

6. The communication interface apparatus according to claim 1, the communication interface apparatus further comprising:
an access controlling unit configured to limit, according to the setting information, access from the first information processing apparatus to setting information that is set for the communication interface apparatus.

7. The communication interface apparatus according to claim 1, wherein
the setting information obtaining unit obtains the setting information from a communication apparatus that is set up at the first information processing apparatus and that is capable of communicating with the second information processing apparatus.

8. A computer-readable recording medium having stored therein a program for causing a communication interface apparatus provided at a first information processing apparatus to perform a process of controlling a communication, the process comprising:
obtaining setting information from a second information processing apparatus that is different from the first information processing apparatus, the setting information including a piece of virtual network identification information corresponding to a virtual network to which the first information processing apparatus belongs from among pieces of virtual network identification information for identifying virtual networks;
setting up the virtual network identification information according to the obtained setting information;
receiving data from a communication network;
applying a filtering process to the received data according to the virtual network identification information that has been set up; and
transferring to the first information processing apparatus the data to which the filtering process has been applied.

9. A virtual network constructing method for constructing a virtual network of a cloud computing system that includes a first information processing apparatus that is an information processing apparatus, and a second information processing apparatus that is an information processing apparatus different from the first information processing apparatus, the virtual network constructing method comprising:
transmitting, to the first information processing apparatus, setting information that includes apiece of virtual network identification information corresponding to a virtual network to which the first information processing apparatus belongs from among pieces of virtual network identification information for identifying virtual networks by using the second information processing apparatus,
obtaining the setting information transmitted from the second information processing apparatus by using a communication interface provided at the first information processing apparatus,
setting up the virtual network identification information according to the obtained setting information by using the communication interface,
receiving data from a communication network by using the communication interface,
applying a filtering process to the received data according to the virtual network identification information that has been setup by using the communication interface, and transferring to the first information processing apparatus the data to which the filtering process has been applied by using the communication interface.
